(19) United States
(12) Patent Application Publication
(10) Pub. No.: US 2019/0335219 A1
(43) Pub. Date: Oct. 31, 2019

(54) SYSTEMS AND METHODS OF INTERACTIVE PRODUCTION MARKETING

(71) Applicant: AJP Enterprises, LLC, Laguna Niguel, CA (US)

(72) Inventors: Alfred J. Pizzurro, Laguna Niguel, CA (US); Christopher John Falson, Studio City, CA (US)

(21) Appl. No.: 16/287,175

(22) Filed: Feb. 27, 2019

Related U.S. Application Data
(63) Continuation of application No. 16/184,876, filed on Nov. 8, 2018.
Application No. 16/184,876 is a continuation of application No. 16/015,575, filed on Jun. 22, 2018, now abandoned.
Application No. 16/015,575 is a continuation of application No. 15/440,340, filed on Feb. 23, 2017, now abandoned.
Application No. 15/440,340 is a continuation of application No. 15/353,514, filed on Nov. 16, 2016, now abandoned.
Application No. 15/353,514 is a continuation of application No. 14/728,214, filed on Jun. 2, 2015, now abandoned.
Application No. 14/728,214 is a continuation of application No. 14/340,295, filed on Jul. 24, 2014, now abandoned.
Application No. 14/340,295 is a continuation of application No. 13/856,081, filed on Apr. 3, 2013, now abandoned.
Application No. 13/856,081 is a continuation of application No. 12/413,244, filed on Mar. 27, 2009, now abandoned.
(60) Provisional application No. 61/043,023, filed on Apr. 7, 2008.

(51) Int. Cl. H04N 21/2668; H04N 21/466; H04N 21/254; H04N 21/258; H04N 21/25; H04N 21/234; G11B 27/036; G06Q 30/02; H04N 21/81; H04N 21/61; H04N 21/4722; H04N 21/2547; H04N 7/173; H04N 21/435

(52) U.S. Cl. CPC H04N 21/2668; H04N 21/4667; H04N 21/2541; H04N 21/25891; H04N 21/251; H04N 21/23424; H04N 21/435; G06Q 30/02; H04N 21/812; H04N 21/6125; H04N 21/4722; H04N 21/2547; H04N 7/17318; G11B 27/036

(57) ABSTRACT

A viewer of broadcast media requests or receives programming content including advertising over the Internet. The production system manipulates the programming content including the advertising with one or more computer processors to create a video broadcast based on input received over the Internet. The programming content promotes products or services by inserting advertisements or promotional material into the video broadcast based on one or more user interests. In addition, the production system transmits to the user the customized production with the inserted advertisements and promotional material embedded therein.

### INCORPORATION BY REFERENCE TO ANY PRIORITY APPLICATIONS

Any and all applications for which a foreign or domestic priority claim is identified in the Application Data Sheet, or any correction thereto, are hereby incorporated by reference into this application under 37 CFR 1.57.

### FIELD OF THE INVENTION

The invention relates generally to requesting content customizing advertising, requesting advertising and an interactive sales process to viewers of interactive network broadcasts.

### BACKGROUND

Traditional television programming relies on program content being generated in the broadcast studio or received from a communications satellite, microwave link, landline, or cable from a remote mobile production unit. Producers at a single studio location manipulate the program content to produce television programs, which are broadcast to the viewing audience. The television programs are not customized in real time to a particular audience at the time of the broadcast based on viewer input received at the time of the broadcast. Furthermore, it is difficult in broadcast media to provide customized advertisements and promotional information based on viewer interests.

### SUMMARY OF THE INVENTION

The disclosure provided in the following pages describes examples of some embodiments of the invention. The designs, figures, and description are non-limiting examples of some embodiments of the invention. Moreover, disclosed advantages and benefits may apply to only some embodiments of the invention, and should not be used to limit the invention.

In an embodiment, an interactive television network comprises a plurality of programming content where the plurality of programming content is provided by a plurality of content providers. The interactive television network further comprises a production facility that receives the plurality of programming content from the Internet, and manipulates the programming content to create a production. The interactive television network further comprises viewer information associated with a viewer's Internet Protocol address. The viewer information is received over the Internet at the production facility, where advertisements, requested content, requested advertising and or Sales process are added to the production based at least in part on the viewer information substantially at the time the production facility receives the viewer information.

In another embodiment, a method of producing interactive television comprises receiving over the Internet a plurality of programming content. The plurality of programming content is received from multiple sources. The method further comprises receiving over the Internet viewer information associated with a viewer's Internet Protocol address. The method further comprises manipulating the programming content to create a customized production, where the manipulation comprises inserting requested content, advertisements, requested advertising and or sales process into the production based at least in part on the viewer information in real time as the viewer information is received, and transmitting the customized production over the Internet to the viewer.

The interactive broadcasting and marketing system allows viewers to manipulate content, request product advertisements and interact directly with advertisers and sales people in real time.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 is a block diagram of an interactive programming, advertising and sales system, according to an embodiment of the invention.

FIG. 2 is a block diagram illustrating content providers, advertisers and viewers and examples of the interaction between content providers, advertisers and viewers within the production system, according to an embodiment of the invention.

FIG. 3 is a block diagram of the production system of the interactive television programming system, according to an embodiment of the invention.

FIG. 4 is a block diagram illustrating viewers and advertisers of the interactive television system, according to an embodiment of the invention.

FIG. 5 is a block diagram of another embodiment illustrating viewers and advertisers of the interactive television system, according to an embodiment of the invention.

FIG. 6 is a block diagram of another embodiment illustrating viewers and advertisers of the interactive television system, according to an embodiment of the invention.

FIG. 7 is flow chart illustrating viewers of the interactive programming, advertising and sales system, according to an embodiment of the invention.

FIG. 8 is a block diagram of another embodiment illustrating viewers and advertisers of the interactive television system, according to an embodiment of the invention.

FIG. 9 is flow chart of another embodiment illustrating viewers of the interactive programming, advertising and sales system, according to an embodiment of the invention.

FIG. 10 is a block diagram of another embodiment illustrating content providers, advertisers and viewers and examples of the interaction between content providers, advertisers and viewers within the production system, according to an embodiment of the invention.

FIG. 11 is a block diagram illustrating viewers of the interactive television system, according to an embodiment of the invention.

### DETAILED DESCRIPTION OF THE PREFERRED EMBODIMENTS

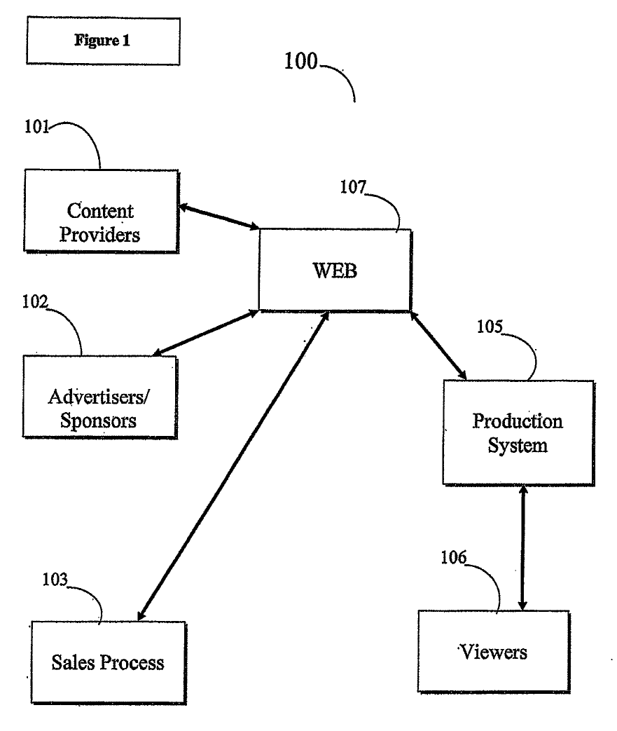

FIG. 1 is a block diagram of an interactive programming, advertising and sales system 100, according to an embodiment of the invention. The interactive programming, advertising and sales system 100 comprises a plurality of content providers 101, a plurality of advertisers 102, a sales process 103, a production system 105 and at least one viewer 106. The content providers 101 transmit a plurality of audio, visual, or audio-visual content to the production system 105 through a communication medium 107. In an embodiment, the content comprises streaming media, streaming video, streaming audio and video, and the like. The advertisers 102 transmit a plurality of audio, visual, or audio-visual advertising to the production system 105 through a communication medium 107. In one embodiment the advertising 102 and the sales process 103 content is audio, visual, audio-visual, text and the like.

The production system 105 receives the plurality of content from content providers 101 and a plurality of advertising from advertisers 102 and manipulates the content and or advertising to produce a production. In another embodiment the production system 105 can manipulate content and or advertising at least in part by viewer input 202. In one embodiment viewer input 202 can be request content 803, request advertising 807 and interacting with the sales process 103 and the like. In one embodiment the production system 105 can manipulate content and or advertising by editing, adding, deleting, or changing music, commentary, graphics, sound effects (Foley), video and the like. In another embodiment the production system 105 can manipulate the content and or advertising using keying technology, holographic technology and the like.

The production system 105 transmits or broadcasts the production through the communication medium 107 to the viewers 106. In an embodiment, the production system 105 also transmits the production through the communications medium 107 to the content providers 101. In yet another embodiment the production system 105 transmits the production to the advertisers 102. In an embodiment, the production comprises at least one of streaming media, streaming video, streaming audio, streaming audio and video, and the like.

Focusing now on the communication medium 107, in one embodiment the communication medium 107 is the Internet, which is a global network of computers. In another embodiment, the communication medium 107 can be any communication system including by way of example, dedicated lines, telephone networks, wireless data transmission systems, two-way cable systems, satellite systems, customized computer networks, interactive kiosk networks, interactive television networks, and the like.

Focusing on the sales process 103, in one embodiment the sales process 103 is managed by the viewer 106. In another embodiment the sales process 103 can be managed by the production system 105, the content provider 101, the advertiser 102 and or the pay-per-view sponsor 102 and the like.

The viewers 106 receive the production from the production system 105 through the communication medium 107. In an embodiment, the viewers send viewer input into the production system 105 to manipulate content, advertising 102 and or the sales process 103.

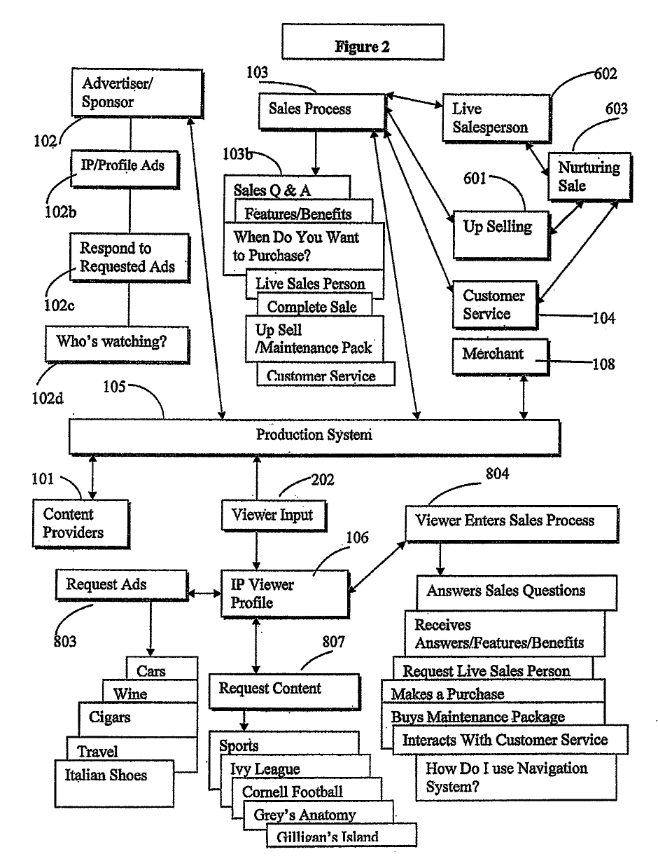

FIG. 2 is a block diagram illustrating interaction between advertisers 102, the sales process 103, content providers 101, viewers 106 and the production system 105, according to an embodiment of the invention.

In one embodiment the production system 105 receives programming content from content providers 101 and advertising from advertisers/sponsors 102 through a communication medium 107, such as the Internet. In one embodiment the production system 105 manipulates content and advertising to produce a product, which is streamed to the viewer 106. In one embodiment viewer input 202 allows the production system 105 to manipulate both content and advertising to produce a product more to the viewer's 106 tastes and or preferences. In another embodiment the production system 105 allows the viewer 106 to interact with advertisers 102. In another embodiment viewer 106, interaction with advertiser 102, leads the viewer 106 into the sales process 103. In one embodiment the production system 105 streams relevant data such as viewer input 202, viewer IP and or viewer profile 106, and or request ads 803 and the like to the advertiser 102. In another embodiment, advertiser 102 uses data such as viewer input 202, viewer IP and or viewer profile 106, and or request ads 803 and the like to target individual and or groups of viewers 106. In another embodiment, the production system 105 allows advertisers 102 to replace existing advertising in a production with new advertising based on viewer input 202, viewer IP or profile 106, and or requested advertising 803, and the like, to target individual viewers and or groups of viewers 106. The production system 105 allows advertising to be replaced and or inserted during live broadcast events 406 and or pre-recorded events 406. In one embodiment advertisers 102 respond to viewer interaction 106 by streaming IP or profile ads 102b and or respond to requested ads 102c and the like, through the production system 105 and onto the viewer 106.

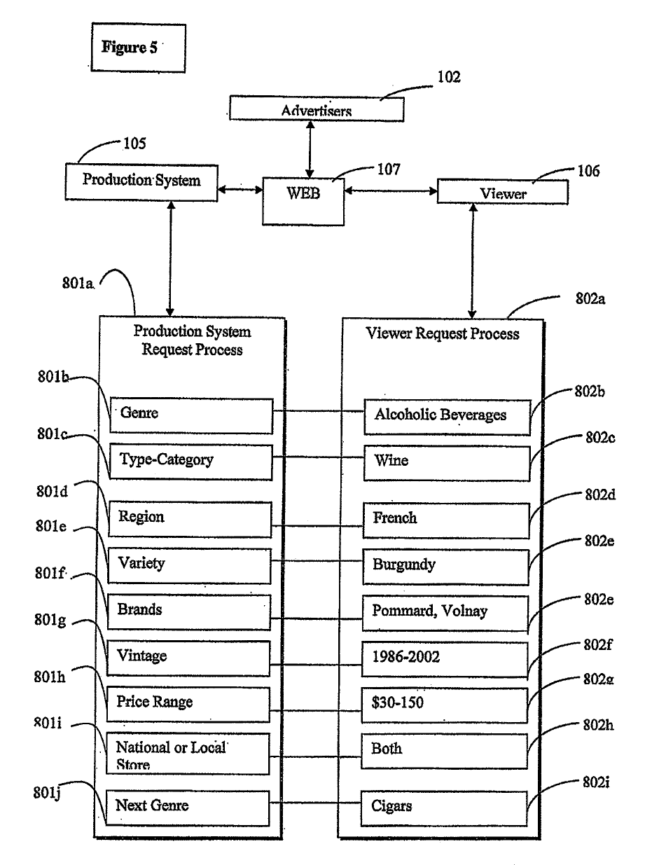

In one embodiment the viewer 106 enters the requested advertising process 803. In one embodiment the viewer's 106 action of requesting ads 803 enters the production system 105. The production system 105 alerts advertisers and sponsors 102 of the viewer's 106 desire for specific product and or service advertising. For example, the viewer 106 enters the request ads process 803 and selects product and or service genres that appeal to him/her. For example the viewer 106 selects cars, wine, cigars, travel, Italian shoes. In one embodiment, the viewer IP 106 and the viewer's requested ads list 803 enters the production system 105. In another embodiment, the production system invites advertisers and sponsors 102 of such products as cars, wine, cigars, travel, Italian shoes and the like, to advertise their products in the productions and or events 406 streamed to this particular viewer 106. Requested advertising 803 will be shown in more detail in the description of FIG. 5 seen below.

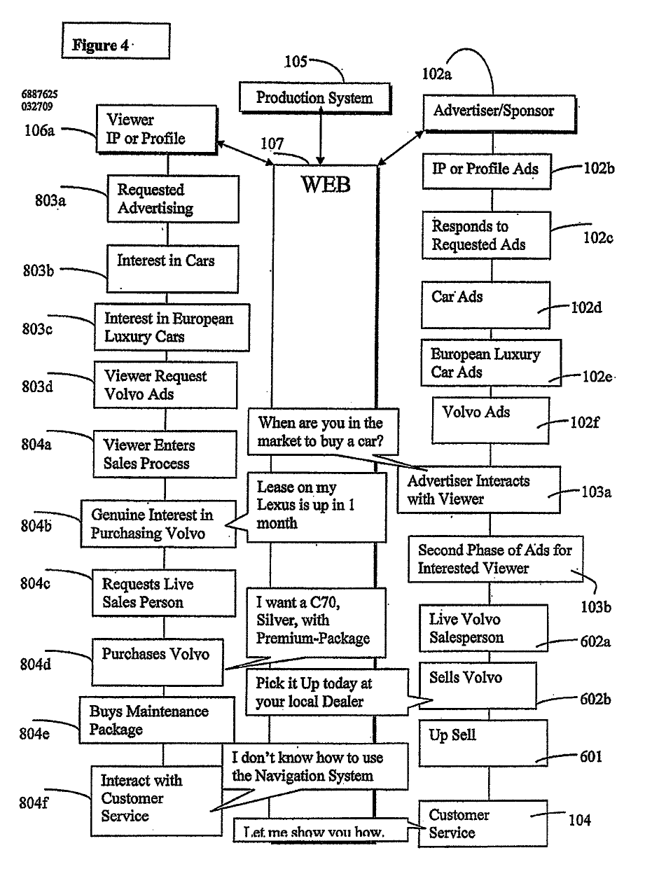

In another embodiment, the viewer's 106 interest in products and services alerts advertisers and sponsors 102 and the viewer 106 is invited into the sales process 103. In one embodiment, through the process of requested ads 803, the viewer 106 shows interest in luxury cars and enters the sales process 103b. In one embodiment, each product and or service has a unique sales process 103. For example, the viewer 106, after requesting more information on a particular luxury car may enter a question and answer phase, which may assist the viewer 106 discover the features and benefits of the car and assist the seller and or advertiser 102 discover if and when the viewer 106 wants to purchase the car. Then, for example, the viewer 106 could request a live salesperson 602. In one embodiment the live salesperson 602 completes the sale and leads the viewer 106 to up selling 601. For example the live salesperson 602, has the opportunity to build a relationship with the viewer 106, and after explaining the benefits of the maintenance package, the viewer 106, agrees with the up selling 601, and purchases the maintenance package. In another embodiment, the interaction is between the viewer 106 and customer service 104. For example the viewer 106 needs a 20,000-mile check up for his car and customer service 104 arranges a loner car while viewer's 106 car is serviced. In another embodiment, customer service 104 can be automated and or involve a live person. In another example, the viewer 106 needs help with the navigation system and interacts with a live customer service agent 104, who shows the viewer 106 how to operate the navigation system by using multi-media presentations and or takes control of the viewer's 106 navigation system via a remote control system to better demonstrate the features and the like. Another example of the sales process 103 and the interaction with requested advertising 803 can be seen in the description of FIG. 4 below.

In another embodiment, while in the sales process 103, the viewer 106, may enter a nurturing phase 603. In one embodiment, the viewer 106 is not ready to make a purchase but is still interested in the product. For example, during a question and answer phase, a viewer 106 tells the advertiser 102 that he has six months remaining on his current lease. In one embodiment the advertiser 102 stays in contact with the viewer over the next six months, streaming tailor made ads through the production system 105 to the viewer 106. In another embodiment the viewer 106 may be nurtured 603 by a live salesperson 602. In another embodiment, the viewer 106, after making a purchase, is nurtured 603 towards the up selling phase 601. In another embodiment customer service 104 nurtures the viewer 106. In one example customer service 104 continues to build a relationship with viewer 106 nurturing the next purchase or up sale 601. In one embodiment the nurturing phase 603 can be managed via an interactive automatic response system within the production system 105 and or a live person acting as a content provider 101. The production system 105 also allows viewers 106 to interact with such interactive and intuitive software programs such as a Sales Bot. In one example, the viewer 106 chats with a sales-bot via text, short message system (SMS), speaking and the like, to search for products and or content. In another example, the viewer 106 gives the sales-bot a list of questions pertaining to products, prices, availability, alternative products and the like, and the sales bot returns, either with a complete list of answers and or when it has the answer to each question.

In another embodiment, the viewer 106, uses a mobile interactive device such as a cell phone or iPhone and the like, to interact with advertisers 102 throughout the sales process 103. For example, Viewer A can interact over a period of time with an advertisers using SMS messaging and the like. In another example, the Viewer, using a portable communications device, monitors the advertiser interaction, such as price changes, product benefits, other Viewer interaction, and the like. The sales system 100, allows the advertiser 102 to nurture 603 the viewer 106 24/7. The viewer 106, is also able to interact at his/her convenience by using mobile interactive communication devices such as cell phones, iPhones and the like.

In another embodiment, viewer 106 enters request content 807 information into the production system 105. In one embodiment, a viewer 106 creates a unique programming experience by manipulating content and or advertising in the production system 105. For example, a viewer 106 creates a type of wish list that includes his/her favorite content. In another example the viewer 106 selects a genre in requested content 807 such as Sports, then selects Ivy League and then Cornell football. In one embodiment, the viewer 106 watches all the Cornell Football games whenever he/she chooses. In another example the viewer 106 enters the production system 105 and creates a requested content list of favorite programming 807 that includes new episodes of Grey's Anatomy and re-runs of Gilligan's Island. In another embodiment, the production system 105 alerts content providers 101 and advertisers and sponsors 102 of the viewer's 106 requested content information 807. In one embodiment the viewer's 106 interest in certain programming content may encourage advertisers 102 to target the viewer 106 with specific product and or service ads. For example, viewer A 106 requests the full season package of the NY Giants games. In one embodiment, the viewer A information 106, encourages advertisers 102 seeking out all NY Giants fans and their product interest and or buying habits and the like, to place ads in the NY Giants events 406 streamed to the viewer A 106. In one embodiment advertisers 102 bid for placement in the viewer requested content 807. In another embodiment, a viewer requests pay-per-view content 807. In one embodiment, an advertiser 102 pays the viewer 106 cost for the pay-per-view content, and or the content providers costs, for the right to stream targeted ads to the viewer 106.

In one embodiment, the sales system 100 allows the production system 105 to identify specific viewers 106 and or groups and or multiple viewers 106 watching a specific broadcast event 406. In another embodiment, the sales system 100 allows one particular IP address and or profile 106 to have multiple viewers 106 with individual profiles using that IP address. In another embodiment, the sales system 100 further allows each viewer 106 associated with the one IP address to have unique profiles consisting of requested content 807, requested advertising 803, sales process 103 and the like. In another embodiment, the production system 105 provides advertisers 102 and content providers 101 with specific viewer information for each IP address so that each individual viewer 106 and or groups of viewers 106 can be recipients of advertising and content, according to their request content, request advertising and or sales process and or profiles and the like.

For example, the production system 105 identifies IP X as John Smith the viewer 106 and or manager of a certain IP address and profile. However, John Smith has a wife, a teenage son and a 10 year old daughter all living in the same house and each using John Smith's IP as their main source for watching video broadcasts. The sales system 100 allows Mr. and Mrs. Smith and their two children to create individual profiles so that the production system 105, can alert advertisers 102, local merchants 108, content providers 101 and producers and the like, to who is watching a broadcast event 406, who is manipulating content, who is requesting content 807, and who is requesting advertising 803 and the like.

In another embodiment, a viewer 106 creates a viewing profile to assist content providers 101, local merchants 108 and advertisers 102. The sales system 100 allows each individual viewer 106 to have their own profile which could include specific data information relating to request content 807, request advertising 803 and or sales process 103 and the like. In one example, the Smith family uses one IP address and account. Each family member, father, wife, son and daughter creates their own viewing profile that includes request content, request advertising and the like. The sales system 100 allows each family member or viewer 106 to identify themselves prior to and or during a broadcast event 406. In one embodiment, advertising within a broadcast event 406 changes when a new viewer 106 is identified. For example, Mrs. Smith 106 is watching a local news broadcast 406 on her own. The broadcast includes requested advertising 803 and or targeted advertising based on Mrs. Smith's profile. When Mrs. Smith leaves the room to answer the telephone, Mr. Smith sits down on the couch, to watch the news. Mr. Smith 106 can alert the production system 105 of the change in viewership by such methods as entering his password, his ID number, or by clicking an icon 906 and the like. Mr. Smith can then watch the broadcast event with advertising, tailored to his requests and or profile, inserted into the broadcast event.

In another example, John Smith and family could identify certain request content 807 broadcasts as a ‘family event’. “We all watch House and American Idol”. This allows advertisers 102 to target all four of the Smiths. In another example, father and son could select sporting events as broadcast they commonly view together. Mother and daughter could select programming they enjoy watching together. Husband and wife call also choose programming that could be regarded ‘adult friendly’. In another example, These multiple and or specific content 807 and or advertising request 803 profiles allow advertisers 102 and local merchants 108 to target viewers 106, groups of viewers 106 and a particular family of viewers 106 with product advertising. In another example, the sales system 100 allows viewers and or groups of viewers 106 to create viewing profiles for certain broadcasts 406. For example, Viewer X creates a viewing profile for he and friends that watch Monday Night Football together at his house. Viewer X could also create a viewing profile for other viewing moments such as father and son, mother and daughter and the like. Viewer X could save each viewing profile, consisting of such elements as request content 807, request advertising 803 and the like, and save each profile in an icon or widget 901. Whenever there is a change of viewer 106, Viewer X and or any other viewer 106 using the system and or IP address managed by Viewer X 106 could select the appropriate icon and or widget and the like, associated with the viewer profile 106.

In another embodiment, multiple viewers 106 can identify themselves to advertisers 102 while watching an event 406 at the same location and or on a specific viewer IP address 106. For example, Viewers A, B, C, D and E have their own IP address and profile 106 that includes request content 107 and or request advertising 103 data and the like. Normally, each of the viewers 106 watch broadcasting events 406 on his or her own IP system. However, one day Viewers A, B, C, D and E gather at Viewer F's house to watch the last 9 holes of the British Open together. The sales system 100 allows each viewer 106 to identify him or herself while watching a broadcast. The production system 105 then alerts advertisers 102 of additional viewers 106 watching the event 406 on Viewer F's IP address 106. Though the IP viewing address 106 is noted for Viewer F's profile and requested advertising 803 interests and the like, advertisers 102 can now bid for placement for viewers A, B, C, D and E 106.

In one example, Viewer C 106 is considered highly valuable because of certain product interest and or activity within the sales process 103. In another example, though Viewer F 106 has blocked 906 and or shown no interest in Real Estate, the collective profiles and or requested advertising interests 803 of Viewers A, B and C could override Viewer F and allow new advertising not normally associated with Viewer F to be inserted into the broadcast. For example, Viewer F could create a viewing profile that allows a ‘majority rule’ ratio for friends and family viewing events so that advertising requests 803 and the like reflects the viewing audience. For example, Viewer F may invite Viewer X to the event. Viewer X is a person of influence and his thoughts on certain products may be of interest to other viewers. In another embodiment, a viewer 106 could alert the production system 105 where, when, how and or at what IP address he/she intends to watch the event 406. The sales system 100 allows the production system 105, to alert advertisers 102 and or content providers 101 to reconsider ad placements in future broadcast to a particular IP address and or to specific and or multiple viewers 106 at a unique IP address. In another example, multiple viewers 106 alert the production system 105 that they intend to watch a sporting event at a local bar. The advertisers 102 can now bid for one or many of the viewers 106 watching the event 406 at the bar. In another example, the production system 105 notices several common product interests and or requests 803 within a section of the multiple viewers 106 and or the majority of the multiple viewers 106 and alerts advertisers 102 who now bid for ad placement in the event 406. In one example, multiple viewer 106 watching an event broadcast 406 at a theater alert the production system 105, using such devices as cell phones, iPhones, Blackberry's, Laptops, PDA's and the like, that they are there at that moment watching the event 406 at that particular IP address.

In another example, when certain content and or broadcasts are viewed in multi-viewer households 106, advertisers 102 can predict with a measure of certainty which viewer 106 is watching. For example, when a Premier League Soccer game is being watched on a Saturday morning on the IP address of Mr. Smith, without the viewer identifying him/herself, advertisers 102 could assume that one or either Mr. Smith or his son 106 are watching the event 406. In another example, if the ‘Cartoon Network’ is selected advertisers 102 could assume that Mr. Smith's 11 year old daughter is the viewer 106.

In one embodiment, the production system 105 asks the viewer 106 to identify him/herself. The sales system 100 allows advertisers 102 to identify specific viewers 106 to maximize the placement of advertisements. For example, when Mrs. Smith decides to watch a Giants Football game on her own, initially, she may be the recipient of her husbands requested ads 803 and viewer profile ads. To identify a viewer 106, the production system 105 can insert a pop up window into the production to ask the viewer “Are You John Smith?” Mrs. Smith can reply by such methods as clicking on the pop up window, sending a short message system (SMS), or by speaking and or by selecting her name on the screen and the like. Now Mrs. Smith can continue watching a broadcast, that was not identified as one of her favorites, and now, advertising matching her profile, requested advertising 803 and or requested content 807 and the like can be inserted into the broadcast event.

In another embodiment, any user can request content 807 and or advertising 803. In another embodiment a user is a viewer 106, content provider 101, advertiser 102, sponsor 102, merchant 108, producer and the like. For example, a local merchant such as a store manager, an insurance representative, an auto dealership, a manufacturer and the like, could request content 807 from several content providers 101 for the purposes of producing an ad. In another example, a producer requests content 807 from four different content providers 801 to create an ad for a local Seafood restaurant. The producer then offers the ad or new production to other similar merchants 108. The merchants 108 and or advertisers 102 could request the content elements 807 within the ad and/or the actual ad itself. In another example, scouts and or advertising managers find the best and or most successful ads for product types and the like and offer them to merchants 108 around the world.

In one embodiment, the production system 105 allows local merchants and or vendors 108 and the like, to manipulate content to create an ad. In another embodiment, merchants 108 bid to advertise directly to viewers 106. For example, a Shoe Store in Pasadena that specializes in hand made Italian shoes, creates a simple ad by using a piece of Italian music from content owner A 101, and graphics and a photo and or video that he, the merchant 108 created on his own and uploaded into the production system 105. The Shoe Store manager 108 then bids to place ads into broadcast events 406 streamed to viewers identified by such characteristics as viewer IP profile 106, requested advertising 803, requested content 807 and or sales process 103.

In another embodiment, national brand advertisers and or sponsors 102, create ad templates that allow producers, local brand representatives and or brand related merchants 108 to edit advertising content within the production system 105 to create targeted ads for localized broadcast events 406 and or local viewers 106. For example, General Motors creates a national ad campaign and up loads content elements and or several ad templates into the production system 105. Local General Motors dealerships 108 can have their advertiser, or producer upload unique content elements into the production system 105 that will help to promote local events, or local deals, and or upload photos, graphics and or videos promoting their dealership and the like. The local dealer 108 could also insert any of his own production elements into national branded advertisements and or use the national brand content elements and or templates to create a new ad.

In another example, content with little or no interest from advertisers 102, allows advertisers to insert advertising into events 406, with a provision that the advertiser 102 is only charged a fee if and when viewers 106 watch the event and or interact with the ad.

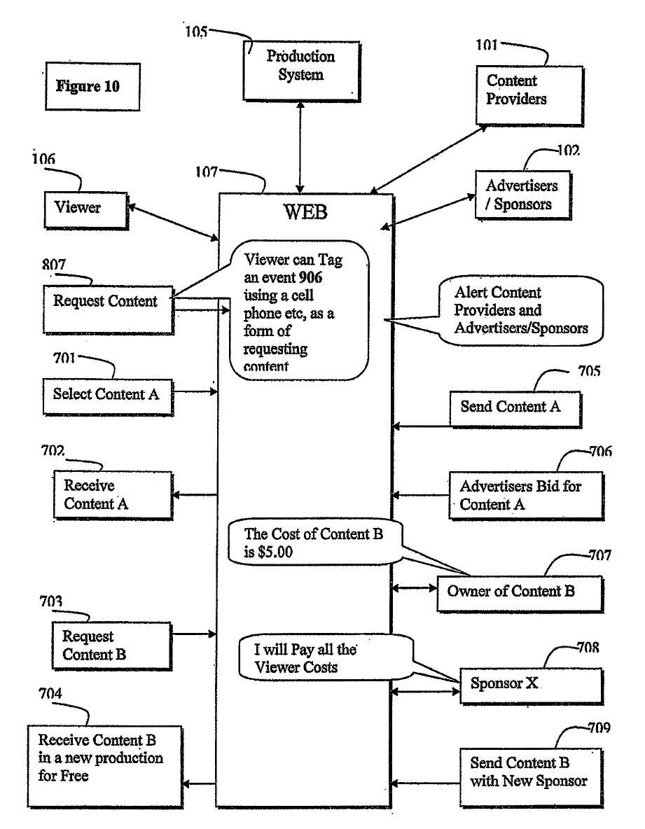

Other examples of the requested ads process 803 can be seen in the description of FIG. 10 below.

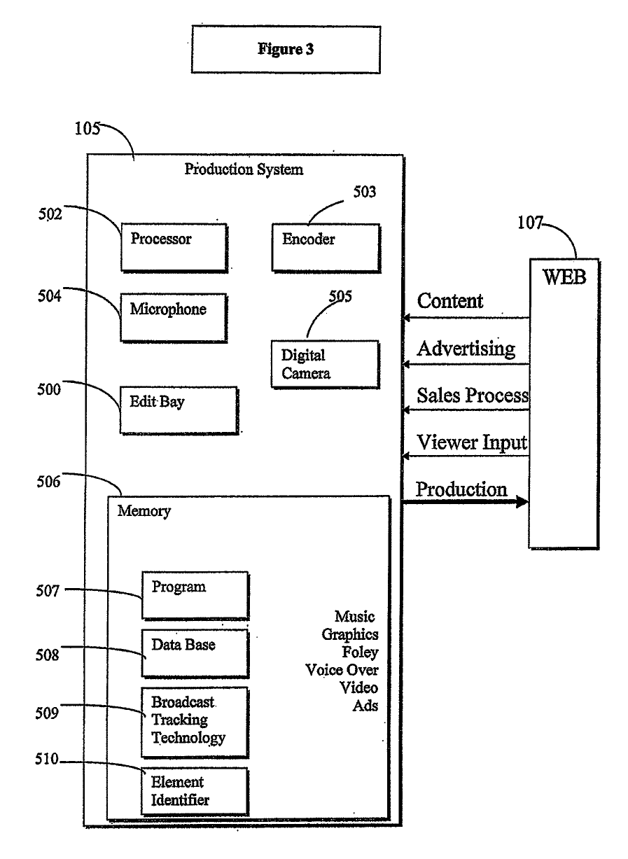

FIG. 3 is a block diagram of the production system 105, and of the interactive programming, advertising and sales system 100, according to an embodiment of the invention. The production system 105 comprises a processor 502 and memory 506. The processor 502, executing program logic 507 allows production system 105 to manipulate the content received from the content providers 101 and the advertising from the advertisers 102. In one embodiment the processor 502 is a computer, which is equipped with a modem, DSL interface or cable interface. In another embodiment the processor 502 can be any device that allows the user to interact with the sales system 100 such as, by way of example, a computer workstation, a local area network of individual computers, a kiosk, a personal digital assistant, an interactive wireless communications device, an interactive television, a cell phone, or the like. In an embodiment, the processor 502 is a server on the Internet.

The processor 502 may comprise one or more computers. The computers comprise, by way of example, processors, program logic, or other substrate configurations representing data and instruction, which operate as described herein. In other embodiments the processor 502 can comprise controller circuitry, processor circuitry, processors, general purpose or single-chip or multi-chip micro-processors, digital signal processors, embedded microprocessors, microcontrollers and the like.

The memory 506 comprises the program logic 507, database 508, broadcast tracking technology 509 and element identifiers 510. In one embodiment the program logic 507 may advantageously be implemented as one or more modules. The modules may advantageously be configured to execute one or more processors 502. The modules may comprise, but are not limited to, any of the following: software or hardware components such as software object-oriented software components, class components and task components, processor methods, function attributes, procedures, subroutines, segments of program code, drivers, firmware, microcode, circuitry, data, databases, data structures, tables, arrays or variables.

The database 508 comprises data used by processor 502 to manipulate the content and advertising to produce a production. In one embodiment the database 508 comprises viewer input 202 such as voting, request content 807, request advertising 803 and the like. In another embodiment the database 508 comprises advertiser input 102 such as advertiser request process 801, bidding 305, sales process 103 and the like. In another embodiment the database 508 comprises audio such as music, live or pre-recorded, sound effects, such as automatic dialog replacement (ADR) and Foley, graphics, key templates, stored audio and video clips, film stock, synthetic 3-D imagery, animation, backdrops, digital still photographs, movies, text, advertising and the like.

The broadcast tracking technology 509 tracks the use of content stored in the database 506 as it flows through the production system 105. In on embodiment, the broadcast tracking technology 509 follows the path of each element of content within a production. In another embodiment, the broadcast tracking technology 509 catalogs the use of each element of content by content providers 101, advertisers 102 and viewers 106. In another embodiment, the production system 105 codes every element of content in the database. In another embodiment, content providers 101 and advertisers 102 use the broadcast tracking technology 509 to code each element of content as it streams into the production system. For example, when content enters the database 509, it is given a unique digital footprint. In another example, each time the coded content is viewed, used, manipulated and the like within the production system 105, the broadcast tracking technology 509 registers the use. In another example, the broadcast tracking technology 509 collates all content usage within a production so that content providers 101 and or producers can receive payment for the pro-rata use of each element of content.

For example, producer A agrees to pay a 10% royalty on all income for the combined usage of content in Production B. Within Production B there are four different pieces of content, each owned by a different content provider 101. Content provider W 101 owns the video content, content provider X 101 owns the music content, content provider Y 101 owns the graphics content and content provider Z 101 owns the voice-over content. At the end of the year the production system 105 calculates that Production A has earned $100,000.00, and a 10% royalty is divided amongst the content providers 105. In another embodiment, the broadcast tracking technology 509 allows content providers 101 and advertisers 102 to track their content, ads and or productions within the production system 105.

The element identifier 510 further encodes all content within in the database 508 and the production system 105 for the purposes of monitoring content ownership and or management. In one embodiment, when each element of content enters the production system 105, proof of ownership and or rights of management for said content may be required. For example, Composer A submits Content X and provides valid ownership of the composition and or publishing. Composer A may be required to give an ASCAP (The American Society of Composers, Authors and Publishers) ID number, or a BMI (Broadcast Music Inc.) ID number. In another embodiment, once an element of content has officially entered the database 508 it is coded by the broadcast tracking technology 509 and the element identifier 510. When content is manipulated within the production system 105, the element identifier 510 calculates each change in the production and notifies the broadcast tracking technology 509 of any new content in the new production. For example, the original Production A uses Content X for English commentary. When an element of change 906 occurs and Content Y (a Spanish commentary) replaces Content X, the element identifier 510 notifies broadcasting tracking technology 509. As Production A is streamed across the Internet 107 it may under go many forms of content manipulation. For example a new language commentary content may replace another commentary 906 time and time again as new viewers 106 desiring their own language commentary activate other elements of change 906. The element identifier 510 keeps track of each change so that content providers 101 and or producers can be rewarded for the use of each piece of content. For example, Producer X agrees to pay the content provider 101 of the commentary to Production C, 1% of all advertising revenues he receives from the production system 105. In another example, the producer of Production C changes the commentary content to suit each region and or viewer 106 based on language. For example, Content provider A 101 supplies the English commentary, content provider B 101 provides the German commentary, content provider C 101 provides the French commentary and so on. The content providers 101 earn a percentage of advertising revenues only when their respective content is used and or viewed within the production. The element identifier 510 and the broadcast tracking technology 509 all the production system 105 to track, record and calculate when and where each element of content is used.

In another embodiment, the production system 105 manages the price of advertising within and or the distribution of income derived from advertising from each production and or event broadcast 406. For example, the production system may offer a 50/50 split on all advertising income with the producers of Production A. For example, the total advertising income is $1,000. In this example, the producer may be responsible to pay an agreed percentage, such as 10% of producer's royalty to the content providers. In another example, the production system 105 is the producer and agrees to pay a 10% royalty for content. For example, the content providers would share on a pro-rata basis the 10% royalty and the production system would keep 90% of the income. In another example, a sponsor 102 manages a pay-per-view event 406 and agrees to pay the production system 105 20% of the pay-per view and the advertising income and the content providers 101 10% of the pay-per-view and advertising income.

In one embodiment, the sales system 100 allows local advertisers 102, acting as producers, to produce inexpensive advertising productions using the production system 105. In another embodiment, content providers 101 share in advertising revenues. For example, instead of charging a production fee to produce an advertisement, a producer offers content providers 101 A, B, C and D a license agreement whereby each shares in a pro-rata payment, each time the ad is used. In another example, the managers of a production pay a license fee consisting of a percentage of all income, whether it be advertising, pay-per-view and the like, to all content owners and or content providers 101 for any use of their content. The production system 105, using both the broadcast tracking technology 509 and the element identifier 510 calculates all license agreements, the content uses, the content ownership and the pro-rata percentages, according to an embodiment. In another example, the manager of a local Hair Salon creates an ad by manipulating content within the production system 105. The manager, acting as a producer, uses a piece of music from content provider A 101, video from content provider B 101, voice over from content provider C 101, graphics from content provider D 101 and a photograph of the Hair Salon that he took himself, which makes him content provider 101 E. The producer promises to pay each content provider 101 a license fee each time a viewer 106 watches and or interacts with the ad.

In another example, a Cadillac dealer produces a high quality production advertisement using content from content providers A. B, C, D and E 101 and instead of paying a production fee, agrees to pay a smaller fee each time the viewer interacts with the ad and a percentage of any revenues garnered from the sales process 103 including any up sell 601. The Cadillac dealer or advertiser 102, saves the immense cost of production and the content providers have the opportunity of earning residual income that may be higher, over time, than the original production fee they would normally charge. The broadcast tracking technology traces the content and the production and advises the production system 105 how much the advertiser 102 owes each content provider 101. The sales system 100 also allows the content owners and or content providers 101 to retain ownership of their content, which can be used in other advertising and or productions. This also allows content owners or content providers 101 greater opportunities to share in revenues accumulated within the production system 105.

The production system 105 manipulates the incoming data to produce a production in a variety of ways. In one embodiment, a viewer 106, using the production system 105 manipulates the data to create a new production. In another embodiment, advertisers 102, responding to viewer requested advertising 803, and using the production system 105 manipulates the data to create a new production. In another embodiment viewer 106, using the production system 105 manipulates advertising content and enters the sales process 103. In another embodiment, the content provider 101 comprises the productions system 105. In another embodiment the advertiser 102 comprises the production system 105. In yet another embodiment the viewer 106 comprises the production system 105.

Examples of manipulation include but are not limited to, adding sound effects (ADR, Foley), music, commentary, graphics, subtitles, language translation, animation, digital and analog special effects, visual special effects, computer generated imagery (CGI), color grading; editing the received content; inserting advertisements and or editing advertisements; voting, texting, recommending, passing on, blocking, requesting, compositing; digital compositing (optical effects); performing voice over, replacing existing voice over; digital cinema technology; using keying technology; sound design and sound designers actions and the like.

Types of keying technology include but are not limited to luminance keying, external keying, downstream keying and Chroma-keying. Using keying technology, the production system 105 can insert advertisements into the production. By knowing the viewer's Internet IP (internet Protocol) address, the advertisements can be tailored to the individual viewer's preferences, based at least in part on the program the viewer 106 selects along with the other data compiled on IP addresses through all embodiments herein. In one embodiment, using keying technology, product placement is digitally added to content based on viewer IP 106. In another embodiment two viewers 106 watching the same live football game (event) 406 see a different ad on the 50 yard line; the production system 105 places advertiser X's 102 product brand on the 50 yard line for Viewer A 106, while simultaneously placing advertiser Z′ 102 product brand on the 50 yard line for Viewer B 106. In another example, viewer A requests advertising 803 for the Jaguar XK Coupe. Viewer A is watching a feature film with an incredible car chase. Using keying technology the original car (a BMW Coupe) driven by the hero is replaced by the Jaguar XK Coupe.

Other examples of the production system's ability to manipulate the content are provided in the various embodiments of the interactive programming, advertising and sales system 100 described below.

In an embodiment the production system 105 further comprises the encoder 503. In an embodiment, the encoder 503 is a 2-way encoder 503 and the production system 105 sends and receives content and productions through the communication medium 107.

In another embodiment the production system 105 further comprises at least one of a camera/video recorder 505 and a microphone or audio device 504, as described above. In another embodiment the production system 105 provides pre-recorded and or produced content. In another embodiment, the production system comprises memory 606, program 507, processor 502 and edit bay 500.

In another embodiment, producers edit content using the edit bay 500. In one embodiment, the edit bay 500 is accessed through the web 107 from a laptop or PC and the like. In another embodiment, the edit bay is comprised of program 507, database 508, processor 502 and encoder 503. In one embodiment, the production system 105 and more in particular the edit bay 500 enables producers, content providers 101, advertisers 102 and viewers 106 to edit and or create content and or produce productions. In one embodiment, the edit bay 500 provides producers with production based audio and or video software programs. In one example, the edit bay 500 allows producers to use audio production software programs such as Pro Tools, Logic Pro, Garage Band, Cubase and the like to record, edit and or produce audio content. In one example, an audio engineer up loads audio content into the production system 105 and uses software inside the edit bay 500 to mix a song. Once the song is mixed the producer submits the content into the production system 105 for other producers and advertisers 102 to use. The edit bay 500 allowed this audio engineer to become a content provider. In another example, a producer uses audio content within the production system 105 and remixes and edits music and audio files using the edit bay 500 to create new content.

In another example, the edit bay 500 allows producers to use video production software programs such as Final Cut Pro, Avid, Avid Express Pro, Adobe Premiere, VirtualDub and the like to edit and or produce content. In one example, a producer up loads various video elements and uses the edit bay 500 to produce a video production. In another embodiment a producer edits video and audio using the edit bay 500 to produce content. In another example, an advertiser 102 produces an ad, using content from various content providers 101 and editing all the pieces together with the edit bay 500. In another embodiment, the edit bay 500 provides and or allows open source production software programs. In another embodiment, the production system 105 encourages viewers 106, content providers 101, advertisers 102 and producers to develop open source production software programs within the production system 105.

In another embodiment, the edit bay 500 allows producers to produce an edit such production elements as Keying Technology, CGI, animation, graphics, language translation, Foley, ADR, audio, video, music, photography, film, 3D, advertising and the like. For example, a producer produces an animated children's video using software programs within the edit bay 500. In another example, a producer up loads an existing ad template and edits into the production keying technology elements, new graphics, new music, new sound effects, new ADR using the edit bay 500.

FIG. 4 is a flow chart illustrating an interactive programming, advertising and sales method and more in particular the process of requested advertising 803. In one embodiment the production system 105 receives viewer advertising requests 803 and advertising from advertising/sponsors 102 through a communication medium 107, such as the Internet.

In one embodiment, the production system 105, manages the data flow and interaction between the advertisers/sponsors 102 and viewers 106. In one embodiment, advertisers 102 target viewers 106 by sending IP and profile ads 102b based on the viewer IP address and or their profile and or preferences 106a and the like. In another embodiment a viewer 106a submits requested advertising 803a to the production system. In another embodiment, advertisers 102a, use viewer requested advertiser information 803a to produce specific and or targeted advertising for the viewer 106. In another embodiment, viewer requested advertising 803a allows advertisers 102a to respond to requested ads 102c via the production system 105. In one example viewer 106a shows interest in cars 803b and receives car ads 102d from the advertiser 102a. In another example, viewer 106a defines his interest in European luxury cars 803c and receives European luxury car ads 102e. In another example viewer requests Volvo ads 803d and receives Volvo ads 102f. In one embodiment the viewer's 106a interest in Volvo is such that the viewer enters the sales process 804a. In another embodiment the advertiser interacts with the viewer 103a. In another embodiment the viewer shows genuine interest in purchasing a Volvo 804b, which allows the advertiser to move into the second phase of ads for interested viewers 103b. In one example, an advertiser 103a asks the viewer 804a, “when are you in the market to buy a car?”. In another example the viewer 804b answers “The lease on my Lexus is up in one month”. In another example the second phase of ads 103b are less about branding and more about the features of the product. In another example the second phase of ads 103b help the advertiser 102 to focus on the needs or desires of the viewer 106 rather than trying to sell him/her on the product.

In another embodiment the production system 105 alerts competing European luxury cars advertisers 102e of the viewer interest in purchasing a Volvo 804b. In one embodiment, Mercedes offers the viewer 106 a better deal on a car. In one example, the viewer 804b indicated that safety was a major factor in purchasing a Volvo. In one embodiment, production system 105 alerts other European car advertisers 102e with a high safety rating. In one embodiment, the viewer 106 reconsiders and buys a Mercedes. In another embodiment, Mercedes and Volvo compete for the viewer 106 by lowering prices and or offering bonus packages.

In another embodiment the viewer requests a live salesperson 804c. In another embodiment a live salesperson 602a begins to interact and or negotiate with the viewer 106. In another embodiment the viewer decides to purchase the Volvo 804d. In one example the viewer 106 tells the live salesperson 602a “can I order the Volvo C70, in Silver . . . and I want the premium package too”. In another example the live salesperson 602a answers by saying “Sure thing. The Volvo C70, in silver, with the premium package will be ready for pick up at your local Volvo dealer at 3 pm today”. In one embodiment, the interaction between the viewer 106 wanting to purchase the Volvo 804d allows the advertiser 102a to sell the Volvo 602b to the viewer 106.

In another embodiment, once the sale is completed, the advertiser 102 directs the viewer 106 into the up sell phase 601. In one embodiment, the viewer 106 agrees to purchase the maintenance package 804e. In another example, without the interaction of a live salesperson 602a the sales process 103 ends at the point of sale. In another example, the live salesperson 602a, uses the production system 105 to show the viewer 106 live video of the car, it's safety features, color options and the like. In another example the live salesperson 602a takes the car for a test drive and by using a wireless audio/video broadcast device, allows the viewer 106 a type of virtual test drive.

In another embodiment the viewer interacts with customer service 804f and 104. In one example the viewer 106 asks, “Can you help me, I can't seem to work out this navigation system?” In another example the customer service agent 104 gives the viewer 106 a lesson on how to use the navigation system.

FIG. 5 is a flow chart illustrating the production system 105, the advertiser 102 and the viewer 106 interaction with regards requested advertising 803. In one embodiment, the data from viewer request process 802a flows through a communication medium 107, such as the Internet, into the production system 105. In another embodiment the production system 105 manages the data flow and allows the production system request process 801a to interact with the viewer request process 802a. In one embodiment, production system request process 801a interacts with viewer request process 802a to determine what product and or service advertising the viewer 106 is interested in receiving.

In one example, the production system request process 801a interacts with the viewer request process 802a in a type of question and answer format to create a defined product. In another example, when the viewer is asked to select a product genre 801b, alcoholic beverages 802b is selected. To further define the product, when the viewer 106 is asked to select from the type—category list 801c, wine 802c is selected. The viewer's selection 106 prompts the production system process 801a to offer a selection of wine regions 801d and French 802d is selected. The production system request process 801a offers a selection of brands 801f and the viewer 106 selects both Pommard and Volnay 802e. When the viewer 106 is asked to define the Vintage 801g, 1986-2002 802f is selected. The viewer is asked to define the price range 801h and $30-$150 802g is selected. The production system request process 801a offers a choice of national or local store advertisements 8011 and the viewer 106 selects both 802h. In another example, the viewer 106 is now ready to receive advertising for French, Burgundy wines from either of the Pommard or Volnay brands. In one embodiment, the production system request process 801a, alerts advertisers of the viewer's 106 desire to receive advertising for the selected wines. In one example, the production system 105, manipulates content so that new advertising, containing the selected wine brands, can be inserted into the production and or event 406 that is streaming to the viewer 106.

In another embodiment, the viewer 106, when asked to select national or local advertising 8011, selects local advertising. In one example, the viewer's IP 106 and the request advertising information 803 allows a local wine store to insert ads into an event 406 promoting the sale of a case of 1998 Volnay Premier Cru. In another example, the viewer 106 responds to the ad, enters the sale process 804a, makes a purchase and then asks for the product to be home delivered. In another example, the viewer 106 discovers other wines on special at the local wine store and enters the up selling phase 601 and buys another case of wine.

In another embodiment the production system 105 allows the viewer 106 activity and interest in the local wine store to alert alternative and or competitive advertisers 102. In one example, a national advertiser 102 offers the viewer 106 a better price on the 1998 Volnay Premier Cru. In another example, multiple advertisers 102 of Volnay and Pommard compete for the business of the viewer 106. In another example, the viewer 106 is able to buy the selected wine at a much lower price than had originally been offered.

In another embodiment, the viewer 106 after completing the initial product selection receives next genre 801j and selects cigars 802i. In another embodiment, the production system request process 801a and the viewer request process 802a interact to develop a catalog of product and or services to fulfill the viewer's requested advertising demands 803. Now, instead of using what could be deemed “shot gun advertising”, advertisers 102 can be more deliberate and advertise their products to interested viewers 106, while at the same time viewers 106 no longer need to watch random advertising but instead are able to become connoisseurs of products, brands, and advertising itself.

In another example, a viewer A and Viewer B download the same podcast at the same time from the same server. When Viewer A and Viewer B selects the Podcast, their respective Viewer IP profile 106 and the request advertising data 803 alerts the production system 105. The production system 105 then inserts the appropriate advertising for each viewer and downloads the Podcast to each viewer 106.

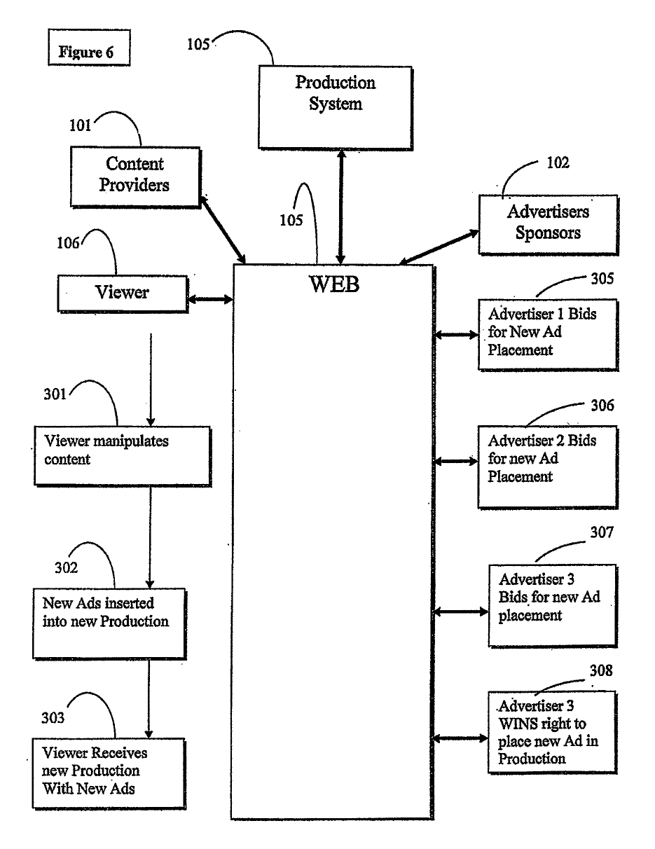

FIG. 6 is a flow chart illustrating viewer manipulation of content 301 and advertisers bidding for new ad placement 305 in a new production, according to an embodiment of the invention. The content providers 101 transmit a plurality of audio, visual, or audio-visual content to the production system 105 through a communication medium 107. The advertisers 102 transmit a plurality of audio, visual, or audio-visual advertising to the production system 105 through a communication medium 107.

In one embodiment, the production system 105 receives the plurality of content from content providers 101 and a plurality of advertising from advertisers 102 and manipulates the content and or advertising to produce a production. In another embodiment, the viewer 106 manipulates content with the production system 105 to produce a new production. In another embodiment, the production system 105 alerts advertisers 102 of the new production. In one embodiment, advertisers 105 bid for placement inside the new production. In another embodiment the program 507 and database 508 within the production system 105 manages the advertiser 102 bidding process. In one example, the viewer manipulates content 301 by adding a new commentary 906 to a Sports event 406. Advertiser 1 305 and advertiser 2 306 enter a bidding process within the production system 105 in an attempt to win the right to advertise their product in the new production. In another example, advertiser 3 308 outbids all other advertisers (305, 306) and wins the right to place an ad in the new production 308. In one embodiment, once the bidding process within the production system 105 is completed, the new ad is inserted into the new production 302 and the production system 105 allows the viewer to receive the new production along with the new ads 303.

In one embodiment, the production system 105 provides the viewer 106 with software program 507 and database 508 to manipulate content 301. In one embodiment, after selecting a production, the viewer 106 is offered several interactive viewing options. The options can be embedded in the content and or the media player. The options can be operated by selecting icons 901 such as key words, URL's, names, photos and the like. The options include the ability to edit or replace visual media, such as video, photographs and the like, commentary, music, text, graphics and the like. In one example, the viewer 106 selects “New Video”, which allows the insertion of new video, and/or the deletion of the current video. For example, Viewer A, an alumnus of Cornell, edits into the 2008 Football Highlights production “new video” of old Cornell sporting events. In one example the new production attracts Cornell alumni viewers 106. In one embodiment, the production system 105 alerts advertisers 102 of the new production and the interest from Cornell alumni. In another embodiment, advertisers 105 that want to target Cornell alumni viewers 106 bid for placement in the new production. In another embodiment, when the viewer manipulates content 301 the action can allow any or all of the original advertising to be replaced by new advertising.

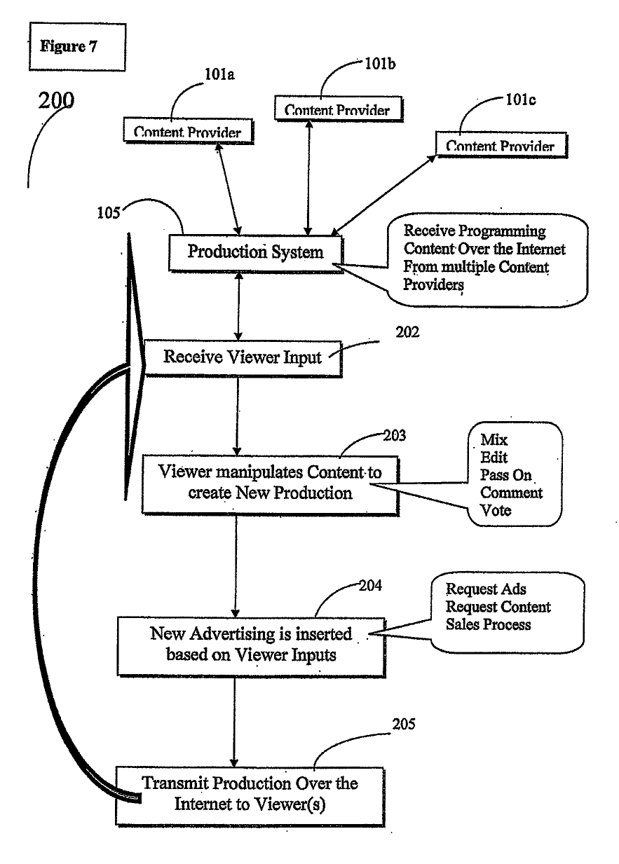

FIG. 7 is a flow chart illustrating an interactive television and advertising process 200, according to an embodiment of the invention. In one embodiment the production system 105 receives programming content from multiple content providers 101 through the communication medium 107, such as the Internet. In an embodiment the program content comprises media, such as streaming audio and/or video files. In block 202 the production system 105 receives viewer input from at least one viewer. In an embodiment the production system 105 receives the content prior to the viewer input 202. In another embodiment the production system 105 receives the viewer input 202 prior to programming content. In an embodiment viewer input 202 comprises requested content 807, requested advertising 803, interacting with the sales process 103, voting, editing, mixing, comments, survey results, viewer preferences, viewer IP information and the like. For example, viewers 106 vote and or select the best player, hit, play etc of a sporting event. These viewer selections allow the producers and directors of the original content to highlight the scenes for future broadcasts. In another example a viewer 106 could request content 807 containing the best NFL touchdowns of 2008, based on viewer voting. This viewer request 807 allows content from a variety of productions and or content providers 101 to be manipulated in the production system 105 to produce a new production.

In Block 203 the production system 105 creates a production by combining and manipulating the program content. In an embodiment, the processor 502 executes program 507 to manipulate the streaming media using keying technology, music, graphics, sound effects, stored video, alternative commentary and the like, stored in the data base 508. In another embodiment the processor 502 executes the program 507 to combine, edit, superimpose, and the like into the streaming media. In yet an embodiment, the processor 502 executes program 507 to manipulate the streaming media based on requested content 807, requested advertising 803 and the viewer's 106 interaction with the sales process 103. In another embodiment the production system 105 manipulates the streaming media, based at least in part on the viewer input 202. In another embodiment the production is modified at substantially the same time the viewer input is received. In another embodiment the production is modified based at least in part on the viewer input 106 in real time.

In Block 204, the production system 105 manipulates content and inserts new adverting 102 to produce a new production. In an embodiment, the processor 502 executes program 507 to manipulate the streaming media based at least in part on viewer input 202. In an embodiment, the production system 105 provides advertisers 102 with viewer input 202, which encourages new advertisers 102 to bid for placement. In another embodiment, viewer input 202 back to the database 508 provides the production system 105 with sufficient information to increase the price of new ad placements for new advertisers 102.

In Block 205, the production system 105 transmits the production to the viewers 106. In an embodiment, the viewers 106 send viewer input 202 as a result of receiving the production. In another embodiment, the viewer 106 sends the viewer input 202 to the production system 105. In another embodiment, the viewer 106 sends the viewer input 202 to the content providers 101. In another embodiment, the viewer 106 sends the viewer input 202 to the advertisers 102. In one scenario the process 200 loops between the blocks 105, 202, 203, 204, 205 and the production can be modified based on the viewer input to create new productions. In another scenario the process 200 loops between 202, 203, 204 and 205.

In another embodiment, the viewer 106 functions as the production system 105 and modifies the original production to create a new production (block 203). The viewer 106 can transmit the production to new viewers 106 over the peer-to-peer networks 402 (block 205).

In an embodiment, viewers 106 become content providers 101. For example, some viewers 106 can be interactively involved in the production by adding video and/or audio such as opinions, new music, new commentary, new language interpretation and the like to the production. The producers can choose to include the opinions of the viewers 106 in their live edits or post event commentary. In one embodiment, advertisers 102 who were not interested in a particular content start bidding for placement in the new production based on the new content provided by the viewer 106. In another embodiment the process 200 enables the live broadcast of an event to include multiple language options. The production system 105 streams multi-language content options that allow a different set of advertisers 102 to place ads into each version of the production.

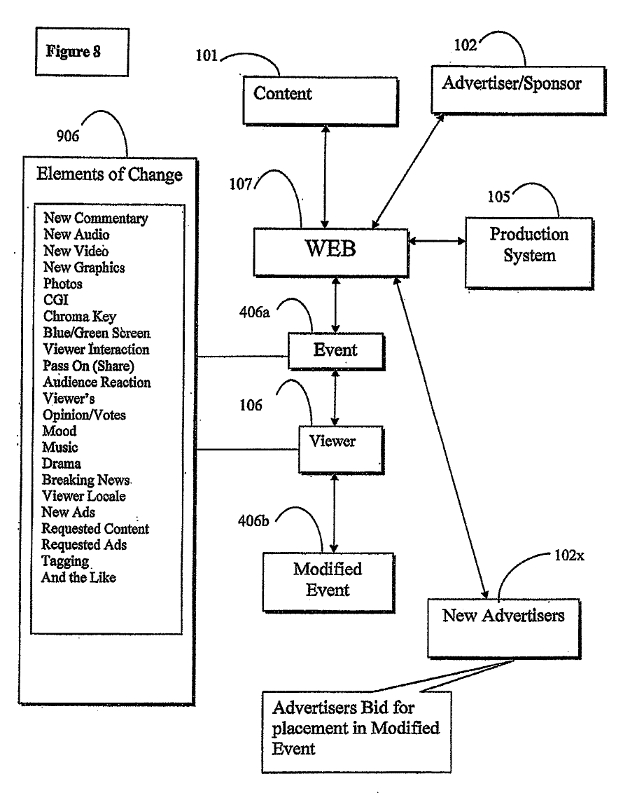

FIG. 8 is a flow chart illustrating elements of change 906 with regards content, according to an embodiment of the invention. The content providers 101 transmit a plurality of audio, visual, or audio-visual content to the production system 105 through a communication medium 107. The advertisers 102 transmit a plurality of audio, visual, or audio-visual advertising to the production system 105 through a communication medium 107. The production system 105 manipulates both content and advertising to produce a new production or an event 406, which is streamed through the web 107 to the viewer 106. In another embodiment, the memory 506, the program 507 and the database 508 within the production system 105 manage the flow and impact of elements of change 906 within an event 406.

In one embodiment, changes within an event 406 can allow new advertisers 102 to insert advertising into the event 406. In one embodiment, new adverting could be requested advertising 803 and or any phase of the sales process 103. In one embodiment, the new advertising can itself be regarded as an element of change 906, which alerts other advertisers 102 to the modified event 406. For example, Rolex inserts it's latest product line ad into a sporting broadcast event 406 and Cartier, noticing the element of change 906, bids to have it's latest product line ad inserted in the sporting event 406. In an embodiment an element of change 906 within the event 406 is spontaneous and or unintentional. For example, during a live concert event 406 an unscheduled appearance by a celebrity-recording artist triggers an alert to advertisers and sponsors 102 who have an association with the celebrity. In another example, the element of change 906 affects the price of advertising within an event 406. For example, an unscheduled appearance of a recording artist during a live concert event 406 attracts other viewers 106 and or fans of the celebrity. For example, the production system 105 evaluates the viewer response and or greater audience interaction within the event 406 and alerts advertisers of an increase in the price of advertising for the event 406.

In one embodiment, the element of change 906 within an event 406 encourages a new advertiser 102, previously disinterested in the event 406, to now bid for placement. In another embodiment, the element of change 906, causes all existing ads to be replaced with new ads and or move the original ads to another timeslot in the event broadcast 406. In another embodiment, the elements of change 906, with in an event 406, alters advertising revenues for content providers 101 and or the managers of the production system 105. In one embodiment, an element of change 906 could be sharing and or passing an event 406. For example, a celebrity recommends and or passes on an event to his/her fan base, which causes an increase in the viewing audience for the event. In another example, Viewer A, as a fan of the Celebrity, receives the recommendation and passes the event 406 onto Viewers B, C and D, neither of whom are fans of the celebrity but trust the recommendation of Viewer A. In one embodiment, the interaction of viewers 106 with the elements of change 906, create revenues for content providers 101 and opportunities for advertisers 102. For example, an event 406 has only one viewer and very little advertiser interest, however the viewer 106 recommends 906 the event 406 to another viewer 106 who passes on 906 the event 406 to all his friends 106. For example, as the event 406 becomes more popular with viewers 106 advertiser 102 interest increases, as does income derived from adverting placements and or bidding.

In another example a live scripted talk show changes direction because of unanticipated audience reaction 906. In another example, words, phrases, subject matter, tone of voice, laughter, playful banter and the like are regarded as elements of change 906. For example, a scripted TV show featuring an interviewer and a Celebrity guest endures an element of change 906 because if the ad libbing and friendly banter between host and celebrity. In one embodiment, advertisers 102, monitor the elements of change 906 through the production system 105 to be better prepared for new ad placements. For example, a Live Chat Show changes the theme of the show because of Audience Interaction and or participation 906. The production system 105 alerts new advertisers 102x of the new subject matter so that new advertising better suited to the new theme, can be inserted into the event. For example, the original theme of the Chat show was ‘Parenting’ and the new theme is ‘Aging’. Advertisers of products and services associated with Aging may capitalize on the moment and bid for placement in the modified event 406b. The process enables a more flexible system for advertisers 102 who benefit from elements of change 906 within the broadcast events 406. The production system 105 empower advertisers 102 with relevant information so that they can make better decisions with regards the producing of and or managing advertising for targeted viewers and or groups of viewers 106.

In another embodiment, a viewer 106 tags content, an ad or an event 906. For example a viewer tags a blog so that other viewers can find it. In another example, a viewer tags a relatively unknown production and passes on 906 the tag to friends and family. In an embodiment a tag is the name of a show, music video, actor, musician, or a key word 901, 906 adopted by events 406, viewers 106, content providers 101, and or producers to use in their content, such as web publications, blog entries, photos, and presentation slides and the like. In another embodiment, the production system 105 and search engines on the Internet 107 can then index the tags to make relevant materials related to the event searchable in a uniform way.

In another embodiment, the production system 105 allows viewers to use RSS as an element of change 906 and to keep track of new content and or new productions. For example, RSS is a family of Web feed formats used to publish frequently updated works—such as blog entries, news headlines, audio, and video and the like. An RSS document (which is called a “feed”, “web feed”, or “channel”) includes full or summarized text, plus metadata such as publishing dates and authorship. Web feeds benefit advertisers 102, content providers 101 by letting them syndicate content automatically through the production system 105 and onto viewers 106. The production system 105 further allows for RSS feeds to be read using software called an “RSS reader”, “feed reader”, or “aggregator”, and the like which can be web-based, desktop-based, mobile device or any computerized Internet-connected device and the like.

In one example, Viewer A sets an RSS alert if and when a touchdown occurs during a football game. The RSS notification provides the viewer with an URL. The viewer then clicks on the URL to watch the touchdown. In another example, an advertiser 102 notifies the viewer 106 of the touchdown. In another example, a video of a touchdown is sent to the viewer, with an ad and product placement inserted into the content based on viewer IP, or profile 106 and or viewer requested advertising 803.

In another embodiment, program 507 comprises a widget engine or the like. In one example widgets 507 are interactive virtual tools that provide single-purpose services such as showing the viewer 106 the latest news, the current weather, the time, a calendar, a dictionary, a map program, a calculator, desktop notes, photo viewers, or even a language translator, production tools, interactive links with advertisers 102, and or content providers and the like. For example, a widget 507 pops up on screen offering the viewer 106 an opportunity to interact with an advertiser 102. In another example, a widget 507 pops up on a screen allowing the viewer 102 to interact with the production. In another example, the viewer 106 drags the widgets 507 onto the computer desktop of a PC or the like to use independently from the broadcast and or event 406 streams. For example, Widget A is direct link with a production tool within the production system that allows Viewer B to edit and produce content. In another example, Widget X is a direct link with an advertiser allowing Viewer C to interact with the advertiser during any stage of the sales process. In another example a widget allows the viewer to discover new content and or request content and or request new advertising and the like.

In another embodiment, the sales system 100 allows viewers 106 to modify content using open source software programming 507. In one example, Viewer A creates a wiki and invites other viewers to enter a collaborative process to produce content. In another example, Viewer B creates a simple open source production tool that allows novice producers to more easily edit and produce content. In another example, the open source program and or wiki developer 106 seeks to involve multiple viewers in an ongoing process of creation and or collaboration that constantly changes and or develops the original program 507.

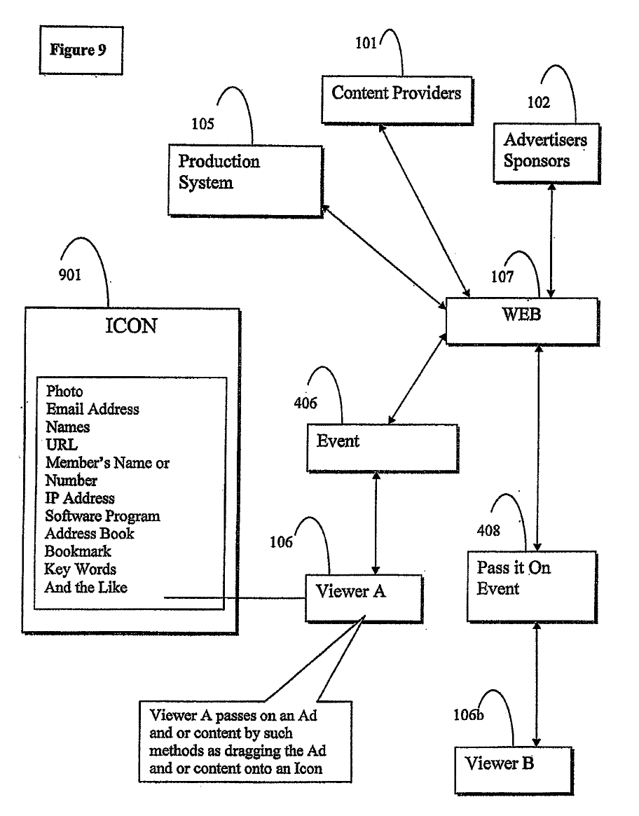

FIG. 9 is block diagram illustrating the element of change 906 of passing on 906 and how this interaction by the viewer 106 inside the production system 105 effects content providers 101, advertisers 102, and events 406, according to an embodiment of the invention. In one embodiment, the production system 105 provides the viewer 106 with production tools to manipulate and or effect change 906 to both content and advertising. In one embodiment, memory 506, program 507 and database 508, assist the viewer to pass on 906 elements of content and or advertising to other viewers 106 and or other content providers 101 and or other advertisers 102. In one embodiment, the production system 105, streams an event 406 to a viewer 106, who then selects an element of the event 406 and passes on 906 the element to another viewer 106. In one embodiment, the element of change 906 becomes part of a pass it on event 408 and is streamed to the new viewer 106b. In one example, Viewer A thinks that Viewer B would appreciate a particular advertisement. Viewer A 106a drags the Ad onto an icon 901 such as a photo, a name, an email address and the like, and the Ad is sent to Viewer B 106b. In one embodiment an icon 901 is a photo, an email address, a name or place, an URL, a viewer and or members name, an IP address, a widget, a software program, a bookmark, a key word and the like.

In one embodiment, the production system 105 charges the advertiser 102 a higher fee for the passed on 906 Ad. For example, the production system 105 recognizes that the ad has greater value when recommended by a friend, family member or other viewer 106 and the like. In another embodiment, the production system 105, charges the advertiser 102 a second fee or higher fee for the original viewer 106 who passes on the ad. For example, the advertiser may be charged a fee when Viewer A watches the ad and then another fee when Viewer A passes on 906 the ad to a friend and or viewer 106. In another example, Viewer A passes on the Ad to a group of viewers such as alumni. Though the viewer only passed on the ad once, the end result was that many new viewers received the ad and the advertiser is charged for the multiple passing on effect. In another embodiment, advertisers 102 deem viewers 106 who pass on 906 ads as of greater value than passive viewers 106. In another embodiment, advertisers 102 change advertising methods and or interaction with a viewer 106 once the viewer 106 has passed on 906 an ad. For example, advertiser X recognizes that Viewer T is already interested in the product and so, instead of sending the ‘branding ad’, advertiser X sends other ads that explain the features and benefits of the product. In one embodiment, the viewer 106 action of passing on 906 allows advertisers 102 to nurture 603 the viewer 106 towards the sales process 103. In another embodiment, viewers 106 that are being nurtured 603 by advertisers 102 can nurture 603 other viewers 106. For example, Viewer A has become such a big fan of Advertiser O's Product Q that Viewer A begins to pass on 906 all the benefits and features of Product Q to Viewers B, C, D, E and F. Advertiser O recognizes the passing on 906 and the nurturing of Viewers B, C, D, E and F by Viewer A, and now considers the new viewers as potential customers of product Q.

In another embodiment, the viewer 106 who passes on 906 the ad and or content could be rewarded by either or the advertiser 102, the content provider 101, or the production system. For example, Viewer A becomes a promoter of Content X, passing on or recommending (in blogs, emails, voting and the like) to other viewers. The content providers 101 of content X pay Viewer A a percentage of revenues generated from Viewer A's passing on 906 actions. In another example, Viewer M's aggressive promoting and passing on 906 of Advertiser Z's product causes an increase in brand recognition and product sales. Advertiser Z agrees to pay Viewer M a percentage of the income derived from a direct result of Viewer M's interaction. In another example, the production system 105, recognizing the consistent and successful passing on 906 actions of Viewer D, offers Viewer D a paid position, with either a salary or a percentage of net returns, to promote content and or advertising to a wider audience.

In one embodiment, advertisement rates vary when the video broadcast is forwarded 906 from the viewer 106 to another viewer 106. In one example, Viewer A, a fan of Russian Soccer forwards Broadcast X, which features the highlights of the Russian Soccer Final to Viewer B who is also a fan of Russian Soccer. Advertisers 102 who targeted Viewer A, based on his IP and viewing preferences may pay a higher fee to advertise to the new viewer 102, who was until then, unknown to them. In another example, Advertisers Y and Z each pay a set fee to place their ads in the broadcasts viewed by 1,000 viewers. However, when the viewers forwarding actions create an additional 1,000 viewers, the production system 105 offers the advertisers 102 a deal whereby they maintain their ad placements in the forwarded broadcasts 906 for a reduced fee. This may encourage advertisers with limited ad budgets to stretch their spending based on viewer actions and or interest 906.

FIG. 10 is a block diagram illustrating the relationship between viewers 106, advertisers 102, content providers 101, and the production system 105, with regards requesting content 807, according to an embodiment in the invention. In one embodiment, a viewer 106 interacts with the production system 105 in the form of request content 807. In one embodiment, the production system 105 provides the viewer 106 with an interactive list of content genre's and or categories and the like. For example, the viewer can select from a wide variety of programming such as sports, history, drama, comedy, music, educational and the like. In another embodiment, the production system 105 interacts with the viewer 106 to develop a unique viewing schedule. For example, the viewer 106 can choose any category and search through the database 508 for any productions or events 406 that he/she wants to watch now or some time in the future. The viewer 106 is able to manage this schedule either by using a dedicated software program on a laptop, PC or cell phone and the like, provided by production system 105 or by using the database 508.

In one embodiment, the production system 105 alerts content providers 101 and advertisers 102 of a viewer's 106 interest in types of content and or request content 807 data. In another embodiment, the viewer's IP and or profile 106 attract certain content providers 101 and or advertisers 102. For example, Viewer A enjoys watching Cricket. Content Provider Y has started a new channel offering cricket and searches through the production system 105 data base looking for viewers 106 who request cricket content 807. On discovering Viewer A's interest in cricket, Content provider Y invites Viewer A to watch and or request the new cricket content. In one embodiment, the content provider 101 is also the advertiser 102. For example, Content provider Y advertises his new ‘cricket content’ in other content streamed to Viewer A.

In one embodiment, the viewer 106 enters the request content 807 mode of the process and submits a request for content through the communication medium 107 to the production system 105. In another embodiment, the production system 105 alerts content providers 101 and advertisers 102 of the viewer's request content action 807. For example, a viewer 106 selects Content A from his schedule, the production system 105 alerts the content provider 101 for Content A. Content A is then streamed to the production system 105. Inside the production system 105 advertising, such as requested advertising 803 and the like, and Content A are manipulated to produce a new production. The new production, which includes Content A, is then streamed to the viewer.

In another embodiment, a viewer 106 tags 906, an event 406 into the viewer's request content 807 schedule. For example, using such devices as an iPhone, a Blackberry, cell phone, laptop and the like, the viewer takes a visual snapshot of a poster, of ad in a magazine, or TV or web video broadcast and the like and sends that snap shot through the production system 105 into the viewer's request content 807 plan. In another example, the viewer records the audio signal of an event 406, and then forwards this onto the viewer's request content 807 schedule.

In another embodiment, a content provider 101 sets a pay-per-view fee for content. In another embodiment, the content provider 101 allows the production system 105 to manage the content in a pay-per-view event 406. In one embodiment, the production system 105 alerts viewers 106 that certain requested content events 807 require a fee. For example, the promoters of a Fight Event 406 inform the production system 105 that every viewer 106 must pay $10.00 to watch the fight. In one embodiment, a sponsor 102, alerted to the content provider's fee for an event 406, agrees to pay all the fees for each viewer. For example, Viewer D requests content B 703. The owner of content B 707 has set a fee of $5.00 for each viewer. Sponsor X wants to promote a new line of products to Viewer D and agrees to pay viewer's fee of $5.00 to the owner of content B 707. Once the production system 105 and or the owner of content B 707 is satisfied that the viewer's 106 fee has been paid, the viewer receives content B in the new production 704. In one example, the viewer 106 agrees to watch all the sponsor's ads 102.

In another example, a Viewer 106 requests pay-per-view content 807 and Sponsors A, B, C and D 102, pay the costs of the pay-per view between them. For example, the cost to view the event is $40.00. When the viewer's content request 807 enters the production system 105 of the four sponsors 102, each of whom having an interest in the viewer because of his locale, his IP address, his profile, his request advertising 803, his interest in similar products, his interest in the sales process 103 and the like, enter bids to have their products and or services as advertising sponsors of the event for this viewer. In another example, one of the sponsors 102 may bid to pay for some of the viewers 106 cost because the viewer is already involved to some degree with the actual sales process 103 of the product. In another example, sponsors 102 may consider this type of sponsoring as a type of nurturing 603 of customers and or viewers 106. In another example, viewers 106 that have been sponsored by certain sponsors and advertisers 102 may feel a sense of loyalty towards a product and brand and tell their friends and family 906 about the actions of the sponsors 102.

In one embodiment, a sponsor 102 pays the content provider costs 101 to enable viewers 106 to receive requested content 807. In one example, Viewer F would like to watch the Giants season on TV, however his cable provider is only offering a full NFL package, which is of no interest to viewer F, nor does Viewer F want to pay the prohibitive costs of the whole season. Using the sales system 100 sponsors 102 can target viewers like Viewer F, and create packaged deals that include the content that viewers are unable to get from their cable providers. For example, Sponsors X pays for the cost of the Giants season for Viewer F so that Viewer F gets to watch the whole season of Giants football for free. In another example, Sponsor X targeting viewers 106 that have requested advertising for products similar to Sponsor X offers each of these viewers 106 a deal . . . “Why buy Show Time if you can pick any Movie you want to see? You request it and I will pay for it”. This allows the Sponsors 102 to spend their marketing dollars on customers or viewers 106 that for one reason or another are interested in their product. This may also create a loyalty from the viewer 106 to the product or service providers 102 who have created an opportunity for viewers 106 to receive content that they might not other wise have been able to see.

In another example, Viewer B wants to watch a Boxing Title Fight 406 but does not want to pay the fee of $49.99. Viewer B can request the content 807 with a provision stating that he is only interested in watching the event 406 if sponsors 102 pay for this requested content 807. Sponsors 102 who have an interest in the viewer 106 are alerted of his provisional request 807 and are able to bid to sponsor the event. In one example, Viewer B agrees to watch all the advertising from the sponsoring advertisers 102 for the fight event 406. In another example, Viewer B agrees to watch the ads and complete a product and service survey. In another example, several sponsors 102 offer a combined subsidy of $40.00 the fight event 406 and the production system 105 informs Viewer B that he can pay $9.99 to watch the fight. In another example, Viewer B 106 requests the fight 406 stating that he would be interested to watch the fight if the price was $20.00. The production system 105 alerts advertisers and sponsors 102 of the opportunity to support and or target viewer B 106, who may already be deemed valuable by certain advertisers and or sponsors 102.

In another example, Viewer A 106 requests HBO 807 at an annual fee of $180.00. Sponsors X, Y and Z 102 bid to pay the viewer costs. Sponsor X 102 wins the bid and offers Viewer A the opportunity to watch HBO 807 for free under the provision that Viewer A watches the sponsors 102 advertising. In another example, Viewer A 106 agrees to participate in surveys provided by Sponsor X 102. In another example Viewer B requests Showtime 807 at an annual fee of $200.00. Sponsor X, Y and Z 102 each win the bid to share the viewer cost, with Z, the highest bidder winning best ad placements and or times during each show, episode, movie and the like for that season. Viewer B agrees that to watch Showtime for free he must also watch the ad placements of Sponsors X, Y, and Z, and the like. In another example Sponsors X, Y, and Z 102 win the bid to cover the pay-per-view costs for a Movie requested by Viewer D 807. For example viewer D agrees to watch the ad placements of Sponsors X, Y, and Z during the broadcast of the pay-per-view movie event. In another example, Viewer D watches the movie uninterrupted and agrees to watch and or interact with Sponsors X, Y and Z's advertising at another time.

In another embodiment, content providers 101 bid for the right to stream content to a viewer 106. In one example content providers X, Y and Z 101 each share the rights to broadcast Event C 406 and bid against each other to win Viewer B 106. For example, when Viewer B requests content C, he is notified that content provider X's fee is $5.00. Content provider Y offers the event for $4.75, content provider Z counters with $4.50 and so on. The winning bid allows the content provider 101 the opportunity to build a relationship and possible ‘fan’ loyalty with the viewer 106 as well the right to place advertising in the event 406 for Viewer B.

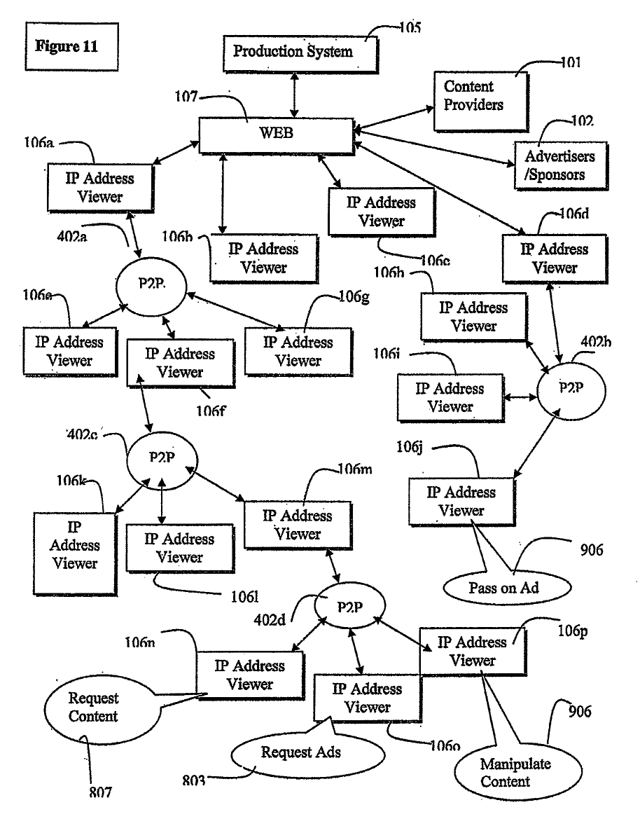

FIG. 11 is a block diagram illustrating the viewers 106 of the interactive programming, advertising and sales system 100, according to an embodiment of the invention. The viewers receive the production through the communication medium 107. The viewer 106 comprises an Internet Protocol address that identifies the viewer on communications through the communication medium 107. In an embodiment, the viewers 106 comprise any device capable of interfacing with the Internet, such as, for example, a computer, a cell phone, a personal digital assistant (PDA), a Blackberry, an iPhone, a digital TV, a high definition TV (HD TV), a global positioning system (GPS), which can provide locations of each viewer 106 or broadcaster or content provider 101 or advertiser 102, in relationship to an event 406, camera 605, production unit, etc., a public broadcasting system in locations such as theaters, malls, stadiums, airports, and the like, a satellite receiver, and the like.

The viewer 106 joins the interactive programming, advertising and sales system 100 by logging onto a URL (uniform resource locator) address, according to an embodiment. In another embodiment, the viewer 106 connects to a peer-to-peer stream. Once the viewer 106 is connected to the sales system 100, the viewer can be offered multiple events 406, or multiple channels or multiple networks of channels of media streaming. In an embodiment, the channels offer a catalog of live and or pre-recorded events 406. In another embodiment, the viewer can watch more than one event 406 concurrently by using multiple or split viewing screens. Once an event 406 is selected, the viewer 106 watches and or listens to the broadcast on a media player such as Windows Media, QuickTime, iTunes, Silverlight, for example. The broadcast process permits the content and or advertising to be modified based at least in part on the viewer's IP or profile 106, history, preferences, requested ads 803, requested content 807 and or interaction during the event 406.

The viewer's Internet Protocol address also permits the viewer 106 to function as a node on the peer-to-peer network 402, according to an embodiment of the invention. As illustrated in FIG. 11, viewers 106b and 106c interface with the communication medium 107 and do not provide in a peer-to-peer network 402. Viewer 106d interfaces with the communication medium 107 and provides a node on the peer-to-peer network 402b. Network 402b further interfaces with a plurality of viewers 106h-106j. Further the viewer 106a interfaces with the communication medium 107 and provides a node in the peer-to-peer network 402a. The peer-to-peer network 402a interfaces with additional viewers 106f-106g, which in turn provide additional nodes on additional peer-to-peer networks, such as networks 402b and 402c. Thus a chain of viewers 106 is created.

In an embodiment, the viewers are interactive viewers 106, such that viewer input from the viewers 106 is transmitted to the production system 105 and or the content providers 101 and or the advertisers 102 through the communication medium 107. In another embodiment the viewer 106 comprises the production system 105 such that the viewer 106 can create a new production. In an embodiment, the new production is broadcast through the communication medium 107 to another plurality of viewers 106. In another embodiment, the new production is broadcast over the peer-to-peer network 402 to another plurality of viewers 106.

Interactive Production-Marketing: The interactive programming, advertising and sales system 100 can involve elements of on-line production during each broadcast event 406, which allows requested content 807, advertising, request advertising 803, and or sales process 103 to be adjusted to suit the needs of each viewer 106 and or group of viewers 106 according to another embodiment.

This process could allow advertisers 102 and or content providers 101 more than one opportunity to sell advertising and or initiate requested advertising 803 and or any phase of a sales process 103 according to another embodiment. The sales system 100 also allows each product to have its own unique sales process 103.

The sales system 100 also enables a more flexible system for advertisers, who may benefit from more precision target market opportunities. The First of these could be called Event Production Marketing, whereby viewer 106 activity and interaction within a broadcast effects what (type of advertising), how (the viewer receives advertising, request advertising 803, and or sales process 103), when (immediately or kept for later), where (the location of the viewer 106, and or placement in the content) and to whom (groups or unique IP addresses 106) advertising, request advertising 803, and or sales process 103 is targeted.

Benefits: The present invention relates in general to a marketing and sales method and more in particularly to a process that allows viewers to receive approved and or requested content 807, receive approved and or requested advertising 803 as well as enter a sales process 103 at anytime during the viewing process. The sales system 100 further allows for every product or service to have its own unique sales process 103.

New technology, such as Sky+ and TiVo, enable viewers to skip ads. However, by better managing digital product placement, Advertisers 102 can be given new ways and more opportunities of reaching their targeted consumers. The process further enables advertisers 102 to nurture viewers 106 (and or customers) via a nurturing process 603. For example, an advertiser 102 can interact with a viewer over time by asking questions, finding out what the viewer wants in a product and or the sales process and thus build a relationship.

The content owners 102, producers, and broadcasters and the managers of the production system 105 can also benefit from greater opportunities in which to sell product placement and or advertising.

This process may also assist in the creation of different versions of DVDs, Video Games, etc for different regions and markets. Often seen as cost prohibitive, new methods of digital product placement may allow for wider distribution, especially of niche products.

For example, gamers from all over the world can play against each other, allowing many opportunities for local and international advertisers and sponsors, who can target viewers (garners) based on their IP address and or locale in real time.

For example, a Skate Board Video Game is produced and sold into the territory of the United States. The original product placement only benefits American advertisers 102. However once the video is released into China, all product placements may be digitally altered to benefit Chinese products, advertisers 102, vendors 108 and viewers 106 and the like. This process could open up new markets of distribution for the content owner and or provider 101 and or distributor or manager of the production system 105. Different versions of each video game could be released for each country, region, or city based on the demands of advertisers 102 and or viewer profiles and or IP addresses 106.

The process may encourage Advertisers 102 to pay a greater fee for and enhanced type of product exposure in one embodiment. For example, a product placement in the center of the screen may have more value than a placement in the upper right hand corner of the screen.

This process may also comprise bidding from advertisers 102 to enjoy placement in new broadcasts.

Interactive Event Marketing

The Viewer Process: In one embodiment a viewer 106 connects to a production system 105 by logging onto an URL address or by connecting to a P2P stream 402. The viewer 106 could use any number of streaming devices such as Mobile Phone, Laptop, Blackberry, PC, PDA, and the like. Once connected to the production system 105, the viewer 106 is offered multiple channels or networks of channels of media streaming. The process allows each channel to offer various streaming qualities and or a catalog of live and or previously recorded content.

In another embodiment, the viewer 106 can play a role in the broadcast (and or production) process. The process allows the Viewer 106 to alter content and or parts of content to create a new production or an event 406.

The process allows the database 508 inside the production system 105 to manage the flow of content from the content providers 101, the actions of each viewer 106, advertiser 102, the merchant 108 and the sales process 103. While other viewers 106 can participate in a unique sales process 103 that differs for each product.

In one embodiment, by selecting an event 406 (live or other) the viewer's IP address 106 is recognized by the database 508. The viewer 106 can also select (view) more than one event 406 at a time (e.g. Multiple Football games). The process allows the viewer 106 to use split screens, multiple screens and or multiple devices to view content. The process also allows the viewer 106 to be the recipient of simultaneous (multiple) advertisements on one or more screens or media players, specifically targeting the viewer 106.

Once an event 406 is selected, the viewer 106 can watch (and or listen) to the broadcast in a media player such as Windows Media, QuickTime and the like. The broadcast process allows content, advertising, requested advertising 803 and or the sales process 103 to be modified based on each viewer's 106 history, preferences, requested advertising 803 and or interaction during an event 406.

The process can allow advertisers 102 to use such methods as Embedded ads (video/voice over commercials), banner ads, event sponsorship, unique product placement (Digital or actual), Pay per Click and the like which can by considered elements of production and can be offered to the viewer 106 inside the actual event broadcast 406, viewed through the media player.

The advertiser's 102 ultimate goal is sales and since every sale has a process and every product has it's own unique sales process 103 the invention allows advertisers 102 to interact with the consumer every step of the interactive media sales system 100. The advertiser 102 can also nurture the consumer base all the way through the sales system 100, from the initial ad to the point of sale. For example, an advertiser 102 can be patient with a particular viewer 106, taking it step by step, by using the viewer information, supplied by the production system 105, such as request content 803, request adverting 807, and the like. In another example, the advertiser 102 ‘woo's’ or romances each viewer with a unique advertising and or nurturing process 603.

This process also allows customers who become loyal to the product brand to recommend 906 products or service to family and friends. In one example Viewers 106 are given advertising and or content templates that allow them to say why they are so loyal to the product or service. In effect the viewer manipulates content elements 906 inside the production system 105 to create a unique ad for family and friends. This viewer action 906 is of immense value to advertisers and may create opportunities for higher advertising revenues for the manager of the production system 105 and or content providers 101.

The process allows the viewer 106 to respond at any time to an ad by such actions as clicking, or dragging an icon 901 into a viewing folder or player, and or tagging other product advertisements through other medium such as TV, Radio and the like. The process further allows the event broadcast 406 and or selected advertising to be paused for viewing at a later time. This type of viewing experience could eliminate much of the advertising methods (currently surrounding a media player during an event) that viewers 106 may consider distractive.

The process could also allow ads outside the Media player to correspond to the ads within the media player. A viewer 106 watching an ad during an event 406 could be offered more ads (banner, click etc out side the media player) by the same advertiser 102 or other advertisers 102 recognizing the opportunity and or viewer 106 interests. In one example, the new ads are not in view and until the viewer clicks on an ad (banner, icon, photo and the like) within the streaming video. At this time, new ads appear outside the media player that allow the viewer 106 to interact with the sponsor using all the embodiments of the sales system 100.

The process could allow ‘traditional’ web ads to be affected by the content, broadcast and or viewer 106 interactions. Though the traditional ad makers may have targeted a viewer 106 (by placing banners and click through ads on the ‘web page), once a viewer 106 responds to an ad inside the media player, this information and activity allows ‘new information’ to stimulate new advertising on the web page (and or inside the media player).

Advertising and or requested advertising 803 may also be affected by the activity and responses of other viewers 106 with similar profiles and or who are watching the same event 406. In one example, when a Viewer requests advertising 803, the viewer can pick from a menu offering the types of products he/she has interest in purchasing at the time.

The process allows the Advertising targeting one viewer 106 to be affected by the activity and responses of other viewers 106 with similar profiles and or who may be watching the same and or similar event 106.

In one embodiment, Viewer A 106 fails to respond to any advertising within the broadcast. However because of the actions of Viewers B through Z 106, who are watching the same event 406, new advertising may be inserted into Viewer A's 106 broadcast event 406 and or web page. This targeted advertising of a particular type of viewer 106 may allow advertisers more confidence to pursue similar Viewers.

The process allows one viewer 106, after discovering an ad or product of interest during a broadcast to forward or Pass On 408, 906 this event 406 to another viewer 106.

In one embodiment Viewer A 106 selects an ad by such actions as ‘dragging’ an icon 901 or URL onto an icon 901 (photo, name, email address, web page, and membership name/number and the like) of Viewer B 106. The ad could then be inserted into an event 406, a web page, an email, a text message and the like of Viewer B 106. Viewer B 106 could accept or reject this ad, or select to view the ad now and or later, or save the ad and or pass on 408 the ad to another Viewer 106.

The process allows viewers 106 to vote for ads. The voting could be based on such values as the effectiveness of the ad, the quality of production, ‘is this ad fun’, ‘is this ad annoying’ and the like.

In one embodiment the collective votes of viewers 106 for an Ad could bring increased audience awareness resulting in potentially higher product sales. In another embodiment an Ad that failed in its initial airing to reach its intended market succeeds because it was deemed the funniest ad. The new notoriety establishes brand recognition amongst viewers 106 and encourages the targeting of the voters for new ads, nurturing into product sales. This process also allows the broadcaster to enjoy increased revenues because of the voting actions of viewers 106.

In one embodiment an ad that has very little viewer 106 attention, generating little Broadcaster income begins to attract the attention of voting viewers 106. The voting of one or more viewers 106 may cause other viewers 106 to interact with the ad and thus increase advertising income to the broadcaster and or the manager of the productions system 105. In another embodiment viewers 106 may be rewarded for such actions as passing on 408 and or voting for an ad.

The process allows the viewers 106 to make their own commercials using content elements within the production system 105. The production system 105 provides production elements such as music, graphics, Foley, software programs and the like to assist viewers 106 in becoming producers and or content providers 101.

The broadcast tracking technology 509 allows every piece of content to have a unique code, according to an embodiment. For example, the code is a digital footprint so that each piece of content, it's value and its usage can be calculated by the production system. In another example, the code could be compared to a bar code on a product inside a super market. When the product enters the supermarket its bar code is scanned, and when it is sold the bar code is scanned. The broadcast tracking technology 509 within the production system 105 monitors all the activity of each content element whether it is in a production, an advertisement, if and when it is being manipulated and or passed on, or tagged and the like.

In another example, every time content is used as part of an advertisement, the broadcast tracking technology 509 tracks and calculates its pro-rata use and assigns payment to the content owner and or provider. In one example, the production system 105 pays content owners 101 at the end of each month and or bi-monthly via such electronic payment systems as PayPal and the like. In another example, an advertisement uses content provided by content providers A, B and C 101 and agrees to pay $0.01 to each provider, each time a viewer 106 interacts with the Ad.

The sales system 100 allows multiple content providers 101 access to multiple advertisers 102 for the purposes of creating inexpensive high quality ads and or reducing the up front costs of production. For example, local merchants and service providers 108 who have not been able to afford high quality advertising on such media outlets as network and or cable television can now cherry pick content from inside the database 508 to create TV quality advertising. In another example, content providers 101 can also participate in advertising production by interacting directly with the merchant. For example, a local cameraman shoots both the exterior and interior of a restaurant. This content is uploaded into the database 508 and then a producer, content provider 101 and or the manager of the restaurant 108 uses this video content, along with a piece of music content from another content provider 101 and a voice over from another content provider 101 to create an ad.

In another example, a producer negotiates with merchants 108 and the like to create ads for no initial up front production costs, however the merchant 108 agrees to pay the producer a percentage of future product's advertising budget based on viewership, placements, and the like. In another example, a producer creates ad templates, using various content elements, for types of advertising. For example, the producer creates an ad ideal for restaurants. Restaurants 108 all over the world could use the ad template, replacing certain content elements that signify the brand and the like, and pay the producer a fee each time the ad is used. This method of production could allow for very inexpensive advertising for local merchants 108 while at the same time allow content providers 101 and producers more opportunities to realize income for their work. In another example, the producer offering ad templates shares in a percentage of the sales process 103 from merchant 108 using the ads.

When content providers 101 submit content they may be required to guarantee that they have the rights of either ownership and or management of the content. Once content passes this examination of ownership it is coded so that the production system 105 can monitor it. The production system 105, and the broadcast tracking technology 509 and the element identifier 510 allows producers, music supervisors and the like to use the request content method 807 to find pieces of content for future productions. For example, a concordance of content allows a music super visor to describe the desired piece of music e.g. “sounds like the Beatles, about relationships, not too sad” and the like. In another example, a producer describes video content e.g. “black and white, 1920's, “people walking the streets of NY” and submits this content request 807 to the production system. Once the producer selects the desired content from his search, then the element identifier 510 will provide the content provider's name, terms of use such as price, and the like and the broadcast tracking technology 509 with provide the producer with such information as, if and when the content has been used in any productions and or advertising.

The process allows the recommended ad to be sent directly to the new viewer 106 from the production system 105. The actions of passing on 906 and or voting for an ad allows the database 608 to further develop the profile of both the initial viewer 106 and the new viewer 106.

Viewer 106 and new Markets: The process allows a viewer 106 to change content within a broadcast 203, which could result in new viewers 106 watching the (altered) broadcast and allowing new advertising to be inserted into the broadcast targeting the new viewers 204.

In one embodiment, the viewer 106, on selecting an Event 406, could be offered several interactive viewing options. The options can be embedded in the ‘channel’ page or as part of the media player. The options could then be activated by such methods as clicking icons 901, dragging key words, using key commands and or voice activation and the like. The options may also include the ability to edit or replace visual media (video, photographs and the like), commentary, music, text and the like 203. The viewer 106 may select new commentary with the option of keeping the original (in which case the new commentary could be considered ‘additional’ commentary) or replacing it altogether. The production system software 507 could allow the viewer 106 to manipulate the event either for his/her own pleasure or for the creation of a new broadcast, which could be live (simultaneous) and or recorded and could be ‘broadcast’ at a later time. The viewer 106 could also us the edit bay 500 to edit audio and video and the like.

The process allows viewers 106 to ignore the options and simply watch and or listen to the event 406 as it is broadcast.

In one embodiment, a viewer's 106 manipulations of content 203 could encourage other viewer's 106, who had little or no interest at all in an event 406, to ‘tune in’ and begin to watch the new production. This action (of the original viewer 106) could also encourage advertisers 102, who had no connection with the original broadcast to bid for placement 305 in the new (altered) broadcast.

New Commentary: In one embodiment Viewer A 106 discovers Event X 406, a sporting event 406 offering only an English commentary. Viewer A 106 could select “New Commentary”. The viewer 106 could then mute the original commentary and using such devices as a microphone 504 and an encoder 503 and or the edit bay 500 Viewer A 106 can record and or mix a new commentary. Using the edit bay 500 this new content can be inserted into the original broadcast live or after the original broadcast was aired. This modified broadcast event 406 can be passed on 408 and or recommended to new viewers 106, friends or family, an affiliate channel or be made available as a public event 406 through the production system 105.

In another example, Viewer A mutes the original English commentary 906 of Event Y and replaces it with a new commentary in Portuguese 906. The new broadcast is made available to Portuguese speaking viewers, which could open up opportunities to advertisers 102 interested in the markets of such Portuguese speaking markets as Brazil and Portugal and or Portuguese speaking people around the world.

The sales system 100 allows local advertisers 102 to participate in globally broadcast events 406. In one embodiment Viewer G living in the City of Alcanena, Portugal discovers Event Y because of the new commentary in Portuguese. Simultaneously an ad is inserted into the new broadcast streaming to Viewer G from a wine merchant 108, 102 also in the city of Alcanena. The wine merchant is able to offer Viewer G ‘today's specials’ and or specific wines that Viewer G has previously shown interest in.

The method of adding new commentary 906 can help ‘new’ viewers 106 discover events 406 in the production system 105. Just as importantly for advertisers 102, the new viewers 106 can offer new market opportunities outside the originally intended viewing market. For example, when Viewer A offers a new Portuguese commentary, a new set of advertising, comprising local sponsors, inline video, banner ads imbedded at the bottom of streaming video, banner ads, click through, voice over and the like can be inserted into the event and or channel page. This element of change 906 can also offer advertisers opportunities to target new IP addresses.

In another embodiment, the New Commentary 906 could be another interpretation of the event 406. The process could allow multiple New Commentaries 906 for the same event 406 intended for niche audiences.

For example, a Golf Tournament Event offers a conservative commentary intended for older male golf enthusiasts. Viewer B adds a new commentary 906 aimed at a Teenage audience, Viewer C adds a new commentary 906 aimed at a female audience, Viewer D adds a new commentary 906 intended to be comedic and opens up a new audience that has never shown an interest Golf tournaments. The sales system 100 allows new productions to target viewer audiences 106 that traditionally have shown little or no previous interest in an event 406. This sales system 100 further encourages advertisers 102, to participate in an event 406 that traditionally offered little or no financial benefits to their product and or interest from their target market.

In another example of the process of elements of change 906: an Ivy League Football match between two rival teams is broadcast. A viewer 106 from each of the various college alumni adds a new commentary, with the new broadcasts appealing to the respective niche alumni viewing audiences. Advertisers 102 are able to bid for each new broadcast, each alumni audience and or each specific viewer 106. The process allows each viewer 106 watching the game to be the recipient of his/her own unique set of ads.

New Visual Media: The sales system 100 also allows Viewers 106 to modify other content such as video in order to change a broadcast according to an embodiment. For example, when View A selects “New Video” he is offered several options such as ‘replace video, edit current video and or insert other video’. In another example, Viewer B, an Alumnus of USC edits in “new video” of old USC sporting events into a game between USC and UCLA. Fellow USC alumni may be more interested watching the new broadcast than the original, which may encourage advertisers 102 to bid for placement. The process also allows the new video to be seen in a second media player window, or section of the event broadcast (corner).

In another example, Viewer C adds “new Photographs” into a production. The sales system 100 allows the new media to match and or differ in quality from the original broadcast, according to an embodiment.

In another example, Viewer D adds ‘new visual media’ into an audio only event 406. The sales system 100 allows the viewer 106 to insert “New Video/Photos” 906 into an audio event to create a new event or modified event 406 and a new broadcast, according to an embodiment. This method of modifying content 906 could elevate the popularity of a broadcast and create greater advertising interest, as well as encourage viewers to engage in requested advertising 803 and the sales process 103. In another example, the viewer uses existing content elements in the database 508 and creates a unique production using the edit bay 500 to edit and manipulate the content. The viewer 106 could then submit the production into the production system and the viewer 106 would become a content provider 101.

New Music/Sound Track: The sales system 100 also allows a viewer 106 to replace and or add an audio soundtrack 906 to an existing video broadcast event 406. For example, Viewer A mutes an existing soundtrack within an event and adds his favorite songs. This method of change 906 could encourage Fans of similar music to view and or share the event with others. This action of modifying content could realize a whole new audience or group of viewers 106 for the original content maker and or content provider 101 and encourage advertisers 101 to participate in a new broadcast event 102.

The method of inserting and or modifying new media 906 allows for multiple interactive viewers 106 from multiple locations, sharing and editing content together. This viewer synergy could alert advertisers 102 to a type of ‘tribal’ or shared interest in products and or services, which could help create a nurturing environment 603 within the sales process 103.

The Advertiser's Process

The production system 105, can provide an advertiser 102 with a list of items or factors that may cause change within an event 406, e.g. new commentary, new audio, new video, new graphics, new photos, CGI, Chroma Key, blue/green screen, viewer input, viewer interaction, pass on, recommending, audience reaction, voting, mood, music, drama, breaking news, viewer locale, new ads and the like. The production system 105 can also provide an advertiser 102 with relevant market information, the activity and results of other advertisers 102 within the production system and or potential viewer 106 information.

The sales system 100 allows advertisers 102, to bid or pay a fee for placement. The sales system 100 also allows Advertisers 102 to place a bid or pay a fee if and when certain changes 906 occur in future broadcasts. For example, Advertiser A, specializing in Mexican Beer sets a bid if and when a new Spanish commentary replaces and English commentary in a College Sporting event. In another example, Advertiser A commits to a higher bid if the IP of a Spanish-speaking viewer connects to the broadcast.

The sales system 100 allows Advertisers 102 to provide the production system 105 with finished ads and or with any relevant information pertaining to markets, IP criteria, bidding and advertising budgets.

Once an Advertiser 102 submits an ad into the production system 105, it can become subject to the governing forces of the production system 105.

The sales system 100 allows for an advertiser 102 to win or lose a placement based on such change factors as advertiser bidding, the introduction of new broadcasts, introduction of new markets, new viewers 105, viewer interactivity, and new advertising based upon any of the other elements of change 906, according to an embodiment.

The sales system 100 also allows an advertiser 102 to manage an event 406 in the form of a pay per view live broadcast event 406, according to an embodiment. In one embodiment, an advertiser 406 may allow some, all or none of the governing forces of the production system 105 to effect the advertising offered to viewers 106. In another embodiment, the advertiser 102, along with the content provider 101 and the managers of the production system 105, shares in broadcast revenues, which may be accrued from viewer payments and or other advertiser income and or delayed (later) on demand viewing.

The sales system 100 allows the advertiser 102 to adjust the bidding (or fee) amounts at any time to increase the likelihood of placement. In one embodiment the advertiser 102 can view a ‘window’ of information showing the status of each of their ads, viewer interest in the ad, viewer interest in similar products, the bids of other advertisers for future events, general viewer interaction as well as information on how to be more successful within the advertising and bidding process. The sales system 100 allows advertisers 102 to change their bid during a live broadcast of an event 406 in ‘real’ time.

The sales system 100 allows advertisers 102 to enter the production system 105 via 3^{rd} party advertising brokers who can act as manages of the event 406 and or the ad placement system or element of change 906. This part of the sales system 100 allows ‘experts’ to monitor such trends as viewer interaction and advertising, requested advertising 803 and or where the Viewer 106 is in the sales process 103, product placements and any of the ‘event change factors’ 906 to help their clients to be more strategic in the placement of ads in current and or future events 406.

The sales system 100 allows Advertisers 102 from international; multi cultural, and or multi lingual societies to submit ads etc into the Database 608 and or production system 105 in preparation for an event broadcast 406 that target their niche market. The sales system 100 further encourages Advertisers 102 to enter an ad placement bid (and the like) for an event or a type of an event 406 based on a variety of viewer 106 related factors such as: location, language, age, notoriety, interactivity (within the process or beyond), number of viewers, or by other process factors such as event (content) shelf life, and or other advertiser's interest, bidding history, and the like.

The sales system 100 also allows Advertisers 102 to bid for the right to advertise to a specific audience and or section of an audience and or unique viewer 106. In one example, two opposing fan bases viewing the same game are targeted by two sets of advertisers. For example, A High School Football game between a school from Mission Viejo and a School from Compton attracts two vastly different viewing audiences.

Based on such variables as demographic, education, income, locale and the like the sales system 100 avails advertisers 102 with viewer information 106 which helps them not only target markets but set different product prices per different viewing audiences. For example, the two sets of viewers of the Mission Viejo and Compton High School game are given the same ads with the same product information but with different price lists. The sales system 100 allows advertisers 102 to create and or modify advertising based on all viewer information 106. For example, Viewer A from Mission Viejo and Viewer B from Compton respond to the same ad and purchase the same product, each paying a different price.

The sales system 100 allows two consumers viewing the same event 406 to be the recipients of two different sets of ads, some of which are in the form of product placements. The Advertisers 102 could select ads for each Customer or viewer 106 based on individual Customer preferences and or interaction activity.

The sales system 100 could allow advertising and or product and or service information to be streamed to such devices as Cell Phones, telephones, PDAs, iPods, PC's and GPS receivers so that viewers 106 can be nurtured in real time all the way through the sales process 103. For example, viewers and or customers can be given important product and service information such as, directions, select your table at the restaurant, choose your seats at a concert or sporting event, have your product wrapped and waiting for you, and the like.

The sales system 100 could provide advertisers 102 with methods that assist them reaching customers who largely ignore advertising. For example, a viewer using TiVo who normally fasts forward through the ads starts to watch the ads because they have been tailored made to his needs or preferences. In another example, Viewer A looks forward to watching ads because of the request advertising 803 options. Instead of fast forwarding through the ads, Viewer A is more interested in the ads because they represent the products and services that he wants.

Other Event Changes Effecting Advertising: Changes within an event 906 can allow ‘new advertising’, such as requested advertisements 803, or any element of the sales process 103 to be inserted into an event 406. The new advertising placement can in itself be considered a production element of change 906.

The sales system 100 allows ‘new advertising’ to be inserted into an event. In one embodiment, the new advertising placement 906 may encourage other advertisers 102 to bid for placement and or new viewers 106 who are interested in the product to view the event 406. For example, Armani inserts its latest product line advertisements into a live fashion show event broadcast 406, offering viewers the chance to win a new suit or outfit if they promote the event to friends and or other viewers 106. Boss and Calvin Klein notice Armani's interest and action and bid for placement inside the event 406. Calvin Klein also notices the viewer action and offers viewers incentives to pass on its ads to friends, family and other viewers 106.

A Live Concert Music Event could include an unscheduled performance by a Celebrity musician. The Change in the event 906 can trigger an alert to Advertisers 102 who share an interest of association with the musician and or with fans (viewers 106) of the musician and or similar musicians. This change in content 906 may also affect the ‘price’ of ad placements during the event. For example, the original concert event had attracted 100 viewers 106. The impromptu performance of the celebrity musician encouraged viewers to pass on 906 the event to all their friends. Soon the event 406 audience had grown to 1,000 viewers 106 and the competition for ads allowed the price for advertising.

The sales system 100 allows a new advertiser 102, previously disinterested in the event to now bid for placement. This method of advertising may cause existing Ad placements to be either replaced or be placed at another time (or position in the event 406 or on the channel) and or increase the actual current place for ad placement in the event 406.

The sales system 100 also allows changes in an event 906 to alter advertising revenues for the channel and or content providers 101.

A change in an event could simply be ‘sharing an event’ 906, according an embodiment. For example, a Celebrity recommends or passes on an event to his/her fan base, which causes an increase in viewer activity. Both elements of change i.e. The Celebrity recommendation and the new viewer activity, alert advertisers 102 to the new opportunity. In another example, Viewer A, after responding to the Celebrity Recommendation passes on the event to Viewers B, C and D, neither of whom being identified as actual fans of the Celebrity but trust the recommendation of Viewer A. The sales system 100 allows anyone involved in the production, streaming and viewing of content to pass on an event 906 to another viewer 106. The sales system 100 further allows the recommendation and or passing on 906 from one viewer 106 to another to create unseen and or planned advertising opportunities. The sales system 100 further monitors all the passing on actions 906 and the like of any of the participants.

The sales system 100 allows many elements of change 906 within an event 406 to create new opportunities for advertisers, according to an embodiment

Dialog: For example a live scripted talk show changes direction because of unexpected audience verbal interaction. The sales system 100 allows for such elements of change 906 to be Key words, phrases, subject matter, tone of voice, laughter, playful banter and the like. The sales system 100 further allows each element of change 906 to alert advertisers 102.

In one example, a scripted Interview between a TV host and a Celebrity guest changes course by the ad libbing and banter between the host and guest. The subject matter could cause the show to change its format, cutting several scripted scenes. The new topic may be deemed of greater interest to viewers so that the producers decide to ‘stay’ with the new topic.

The sales system 100 also allows the viewers 106 to interact with content producers during a live broadcast by asking questions, instant messaging, texting, interacting via such software as skype and or iChat and the like. The producer can also pole the audience reactions in real time by posting questions and having viewers vote on other viewer's interaction. For example, the producer allows the viewer with the most votes to pose a direct question with the celebrity.

The sales system 100 allows producer of an event 406 to invite the viewer 106 onto the event broadcast 406. For example, during a live talk show, viewers are invited to interact with the host. The producer selects Viewer A as the most interesting viewer 106 and allows the viewer's audio/video interaction to enter the production. In another example the host invites other Celebrity guests (from any where in the world) to be on the show. In another example, the Celebrity passes on 906 the event and or notifies his/her fan club. The fans could receive realtime notification on any number of devices, such as cell phone, iPhones, laptops and the like and or via such domains and or services such as MySpace, Facebook, Twitter, Ning and the like.

The sales system 100 allows the fans or viewers 106 to win a spot (appearance) on the show because of their interaction. For example, how many people they passed the event on to, or the fan whose question or interaction stirred the most viewer interest, or to fans who promoted the event outside the network into such entities as Facebook, Myspace, Twitter, Ning and the like.

The sales system 100 allows Advertisers 102 to be alerted of this new topic and opportunity and further allows for new advertising to be inserted into the event. The sales system 100 also allows changes in the event 406 to raise the value of each Ad placement and could encourage new and existing advertisers 102 to increase their bidding for each placement. For example, the advertiser 102 can also bid to have the Celebrity or his invited guest give a pitch about the product or service. The sales system 100 could create greater advertising revenue streams for the managers of the content and or the channel and or broadcast network.

Mood: The sales system 100 allows such Mood elements of change 906 such as atmosphere, lighting, music and the like to effect change within an event 406. For example, dynamic visual and aural changes during a rock concert stir the live audience into a joyful celebrative frenzy. The changes in the performance and or the interaction of the audience (live or other) could alert advertisers 102 to opportunities of promoting similar artists, future concert events and or other products the advertisers deem pertinent to the moment.

Drama: The sales system 100 allows Dramatic elements of change 906 within an event 406 to alert advertisers 102 and or content providers 101, according to an embodiment. For example, a Current Affairs (news) event interrupts its regular and or planned broadcast because of a ‘breaking news story’. Because the news story is of national interest the element of change could alter the whole tenor of the original event. Certain original ad placements that now may be considered insensitive can be replaced by other ads more sensitive to the dramatic change element.

In another example, a Live Chat Show changes the theme of the show because of Audience Interaction and or participation. The new subject matter could induce new ads based on the theme (e.g. Initial theme ‘The Us Economy’ and the new theme ‘World Hunger’).

The sales system 100 could enable a more flexible system for advertisers 102 who benefit from changes in broadcasts 906 and consumer interest. For example, the information of change elements 906 could empower advertisers to make better decisions relating to the creation and managing of ads for targeted audiences. The change factors could provide focused platforms from which advertisers could reach interested buyers.

The sales system 100 allows a broadcaster or production system 105, and or content creators to benefit from the change in an event 406 because of the potential of added Income derived from Audience follow through and the targeted ‘subject’ based advertising.

In one example, a live comedy event is interrupted by a segment of the audience who do not approve of some the comments made by the celebrity comedian. The audience is divided and soon a loud and heated discussion takes place. The dramatic change element 906 could effect how advertising is used and or placed within the Event 406. The sales system 100 allows the production system 105 to either alert the original sponsoring advertiser 102 to modify the planned comedic ads interspersed throughout the comedic event 406 and or replace any or all advertising with new advertising that either compliments and or befits the change in the event 906.

The sales system 100 allows Viewer 106 interaction during an event 406 to be an element of change 906 and thus alert advertisers 102. In one embodiment, a viewer 106 interacts, using such devices as a microphone 504, a video camera 505, a sound card 503 and the like, with a live talk show host. The Viewer 106 interaction causes a change of dramatic tone 906 within the event 406, which alerts new viewers 106 and new advertisers 102.

The sales system 100 also allows Viewers 106 to alert the production system 105, which then alerts advertisers 102 of changed events within a broadcast. The sales system 100 further allows viewers 106 to warn advertisers 102 of possible change. For example, Viewer A, noticing a change in an event could alert friends, post a comment on the channel and or pass on the event to others with comment warning (or heralding) the change. Viewer A may also see a great opportunity for a product placement and contacts the advertiser to consider the opportunity. The Viewer 106 may be rewarded by the advertiser 102 for this alert action.

Commentary: The sales system 100 also allows a change in the viewing experience and or action within an event to alert advertisers 102 of change. For example, a dull broadcast of a local football game ‘comes alive’ because of the action on the field. The new excitement and enthusiasm of the commentators could spark interest, from new viewers and advertisers. In another example, the amazing comeback of one team during a sporting event could cause euphoria in the viewing audience. Advertisers wanting to capitalize on the euphoric moment could place new advertising for products and or future events that compliment the mood and excitement of the comeback and or victory.

The sales system 100 allows Key elements of change 906 to be monitored by the production system 105 and or by real time Human managers viewing the event 406 so that the ebb and flow of an event, such as a sporting event engages viewer and advertising interest.

The sales system 100 encourages 2^{nd} and 3^{rd} (etc) generation broadcasts and thus could allow advertisers 102 to bid for placement in ‘new and or future broadcasts events’ 406 that may interest types of consumers or viewers 106 and or markets that the original broadcaster or content provider 102 had not considered.

Production System: The sales system 100 allows the production system 105 to manage the content, the broadcasting of content and the distribution of content, the interaction between viewers 106, content providers 101 and advertisers 102 and the international markets and or IP preferences 106 and any other platform and or element advantageous to the system.

The sales system 100 also allows the production system 105 to learn from viewer 106, content providers 101, the sales process 103 and advertiser 102 activities, according to an embodiment.

The content provider 101 furnishes the production system 105 with a list of content and allows the production system 105 to insert advertising and stream new production events 406 to viewers 106. Content providers 101 are able to benefit from the interactive advertising process, requested advertising 803 and or sales process 103 to enhance profitability. Content providers 101 may set limits as to how much a viewer 106 and or the production system 105 can manipulate content but allowing all aspects of the interactive advertising to take place.

The sales system 100 may also benefit older content and content providers 101 who carry content in little demand. For example, most of the older shows are taken off the air (TV) when they no longer bring in the ratings. Via request content 807 fans of the content and gather advertising dollars and broadcast revenues can once again view the old content.

The Viewer and the Production System: In one embodiment, when a viewer 106 logs into the production system 105 system the viewer IP (Internet Protocol address) can be registered in the database 508. Activity, comprising viewing, browsing, interacting, advertising interest, purchases and or sales process, and the like, can be collated by the database 508.

The sales system 100 allows a viewer 106 to become a member, which may incur benefits from content owners 101, advertisers 102 and or the manager of the production system 105 (or the channels and or networks).

Advertisers: In another embodiment, Advertisers 102 may be regarded as Clients of the process. Advertisers 102 can submit ads, bidding information and target market preferences in to the production system 105. As Clients, Advertisers 102 can manage unique data in an effort to maximize advertising opportunities.

In one embodiment, though an advertiser 102 can receive notice of change in an event 906, the advertiser preferences could allow and or ignore any further response concerning a new placement and the like.

Event Changes: The sales system 100 allows the production system 105 to manage and interpret changes within each element 906 of the broadcast. This method could allow for immediate responses within the production system to and from Advertisers 102. This could also permit ‘new’ ads to be inserted into an event 406 in an endeavor to match any change within the event.

The sales system 100 allows the database 508 within the production system 105 to be continually updated with new methods of change, history of changed events, events (and or factors of change) that exhibit a propensity to change, evidence of change and possible symptoms of change.

The process also allows the Data Engine 508 and production system 105 to simultaneously discover change in an event 906, alert advertisers 102, and or producers (monitored by preferences) and or replace advertising.

Defining Change Within an Event: The sales system 100 allows viewers 106 to alert the Change in an event to anyone in the system, by interacting using such methods as texting, voice, email, iChat and the like. This type of viewer activity could alert the Data Engine 508 and or production system 105 on the amount of change, and or the types of change.

The sales system 100 also allows the actions of artificial intelligent programs, such as a Shop Bots to effect how a viewer 106 interacts with advertising, requested advertising 803 and the sales process 103.

The sales system 100 allows software 507 within the production system 105 to be adjusted for each event 406 so that varying degrees of change 906 can be measured and or monitored. For example, elements of change within Event A can be set at a higher level of ‘change’ than Event B. Advertising placement changes can be managed to suit these parameters for both Event A and Event B.

The sales system 100 allows the Database 508 and or production system 105 and or program Software 507 to provide options for global settings and or each event 406 settings. The sales system 100 can further allow the production system 105 to managed and or limit the effect of each element of change 906 with an event 406 with regards advertising. This sales system 100 could realize higher revenues for an event 406, and more competitive bidding and add placement by advertisers 102.

Elements of change 906 that can induce higher advertising revenues may also affect the order of priority within the advertisers' 102 preferences. In one embodiment the list of ‘change elements’, 906 (and their relevant use, success, importance, rating and the like) can be updated concurrently with advertiser 102 and member or viewer 106 ‘actions’, within the production system.

The process allows the production system Software 507 to be programmed to recognize event changes 906 such as moods, language, dialog, drama, advertising and viewer activity and the like.

Methods of Event Advertising

Digital Image and Keying Technology

The sales system 100 allows for such methods as Compositing and Keying technologies and or electro-optical, video, and real-time image processing technologies, to edit in and out of each event 406 such advertising content elements as product names, icons (or trademark, image and actual product) 901 and the like.

For example, a product placement agreement is given to Client X 102 to place a product image on the 50-yard line during a football game. The license agreement is given to X for the markets of Californian and Oregon. Client Y 102 is given the rights to place a different product image on the same 50-yard line of the same game for the markets of Texas and Nebraska. Viewers in the states watch the same game with different digital product placements on 50-yard line.

In another example, a consumer's request 803 of an advertisement allows the new companies image or logo to be inserted into the event 406. During the same event the company and or advertisers logo can be different for every consumer 106 watching the game. This process could be deemed much more valuable to the advertiser 102. If the consumer decides to enter valuable information such as “when they want to buy the product” the sales system 100 can enter the nurture stage 603. This could allow the advertiser 102 into a process whereby advertiser 102 gives valuable product information to the consumer over a period of time leading up to the sale. If the consumer 106 decides to speak, and or give answers that moves them through the sales process 103, or asks to speak with the next available sales representative 602 the consumer's value to the advertiser 102 has increased immensely. This part of the process could excite advertisers because the viewer has been converted into a buyer.

In another example a Digital Icon image of Client X's 102 product is overlaid behind the catcher of a baseball game. Client X 102 pays for the product placement for all viewers 106 within the USA market. However once customers 106 outside the US markets view the broadcast, new Advertisers 102 are able to bid for each new region, country, individual viewer and the like. In another example, Client Y 102 wins the bid for viewers in Mexico to place his product icon and Client Z 102 pays for the right to advertise and place his product icon to all viewers in Europe.

In another example, Client X 102 pays to advertise within the English Commentary Version of the broadcast. However once a new Spanish version is created and subsequently viewed by Spanish-speaking viewers 106, Client Y's 102 property replaces the original advertising.

The sales system 100 could allow advertisers 102 to bid for placement for each individual IP address 106, according to an embodiment. In one example, Viewer 1 and Viewer 2 live next door to each other and are watching the same live Soccer game (event) 406. Advertiser A wins the bid to advertise to Viewer 1 and Advertiser B wins the right to advertise to Viewer 2. Though both viewers watch the same event at the same time, they are the recipients of two separate Ads.

The sales system 100 could allow the ‘original content’ to be used again in another medium such as a film, or DVD and or Video Game with unique product placements in each medium and or territory release.

In one embodiment, several key elements of several famous Football games are included in a “best of” production. Though the production could be considered an archived event, Advertising can change for each viewer 106 based on any of the elements of the Viewer profile and or any elements of change 906. In one example, Viewer A, living in Spain views the archived football event and receives local advertising from vendors 108, 102 in his town, while Viewer A, Living in London receives targeted advertising based on his Viewer profile. The two Viewers are watching the event concurrently and yet are receiving entirely different ads.

In another example, Viewer and Viewer B download the same podcast 406 onto their respective media players. The sales system 100 allows the distributor of the podcast to recognize the IP addresses and thus viewer profiles and or location 106 of both Viewer A and Viewer B. The sales system 100 further allows a different set of ads to be placed in the podcast 406 for both Viewer A and Viewer B.

The sales system 100 could also allow actual product images to be replaced during both live and pre-recorded content.

This sales system 100 may also assist in the creation of different versions of DVDs, Video Games, etc for different regions and markets as well as for individual consumers 106 who have requested advertisement 803. This process 100 could allow the brand or product the viewer requested 803 to be included in the DVD or game and the like. Often seen as cost prohibitive, new methods of digital product placement may allow for wider distribution, especially of niche products.

For example, while Viewer A and Viewer watch the same movie, two local advertisers 102 target each viewer with different visual product placements. One scene of the movie is set outside a coffee shop. Viewer A sees a Starbucks storefront comprising all the relevant icons and the like, while Viewer B sees a Pete's Coffee storefront with all its relevant icons and the like. The actors and action within the movie remain the same however the digital placement of product is altered based on such elements as Viewer profile 106, request advertising, 803, request content 807 and or advertiser bidding 305.

In another example, Viewer A sees an actor drink from a bottle of Miller Lite while Viewer B sees the same actor drink from a bottle of Corona. Both Viewers 106 are watching the same scene in a TV drama. The advertisers 102 of both beer products have targeted the Viewers 106 based on their profiles. In another example the advertisers won the right to place their product advertisement in the broadcast, because of the viewer's beer preferences, locale, age and or income and the like. The sales system 100 allows for the dramatic production elements to be the same for each viewer, however the bidding of advertisers 102 for the right to target each viewer 106 allows the product placements to change.

The sales system 100 allows digital imaging of such advertising elements as product placement and the like to increase the value of ‘old’ content. For example, producers of the original Dean Martin Show allow advertisers 102 to bid for new placement. Icons for new products can be inserted into the original video. This process could increase the value of old content and offer advertisers greater opportunity to reach out to older viewers and or a new set of viewers interested in the content.

In another example, new product placement is inserted into old football games. Advertisers 102 can bid on such criteria as per viewer 102 and or territory and the like, for such digital product placement as the 50-yard line and or digital banner ads inserted into stadium grand stands and the like.

In another example, a producer edits content within the edit bay 500 to replace product placements in content and or events 406. In another example, a producer uses the edit bay 500 to insert and or replace product placements in real time during a live event broadcast 406.

Request Advertising: The sales system 100 allows viewers 106 to request advertising 803 for certain products or services. In one embodiment, Viewers 106 are offered a selection of product genre's such as Sporting Goods, Wine, Toiletries, Clothing, Automotive and the like. When a viewer 106 selects a Genre he/she may be offered another list of specific product types. For example, Viewer A selects Wine. This action allows the interactive software to open up another list describing the types of wine, prices, vintages and the like. The sales system 100 could allow the Viewer 106 to create a list of his/her favorite wines and request product information such as where and when they are for sale, what prices he/she is will to pay for them, how often he/she would like to purchase them and the like. The sales system 100 further allows Advertisers 102 to send product information to pre-approved viewers 106. This method may also enable the viewer 106 to build a complete list of products that he/she is interested in.

The sales system 100 also allows the viewer 106 to create viewing experiences in which advertising plays a genuine and anticipated role. For example, a Viewer watches a pre-recorded event and instead of fast forwarding through the ads, he watches each and everyone. In another example, the Viewer watches one particular ad several times and then requests further product information. The sales system 100 allows Advertising to nurture 603 each viewer 106 by providing approved and requested product information, customer service and or sales assistance.

The sales system 100 also allows Viewers 106 to approve and or reject advertising for certain products. The sales system 100 also allows for every product genre or type such as music, automotive, furniture, real estate and the like to have it's own sales process 103.

Sharing an Event (Pass it On): The sales system 100 can encourage 2nd, 3rd 4th and the like productions of a broadcast. In one example a sporting event offering an English language commentary can be altered by Viewer A to include a new Spanish commentary. Viewer A then shares the broadcast with friends and friends of friends in Spain. Because the advertising placed into the initial broadcast was targeted to an ‘English’ speaking target market, the ‘new’ audience may have little interest in the products. The ‘old’ advertising could be deemed ineffective and poorly targeted.

The sales system 100 allows for the second-generation broadcast to allow to re-sell the advertising spots and or placements to target these new audiences. For example, this method could continue on and on as new Viewers 106, producers, content providers 101, advertisers 102, merchants 108 and the like manipulate ‘content’ and or pass events on 906 from one user to another so that new niche audiences or fan bases are nurtured 603. This sales system 100 could create advertising opportunities that could be otherwise unavailable in traditional broadcasts.

For example, Viewer B in Spain discovers the new broadcast (or channel, or network) of Event X and replace the Spanish commentary with an Italian Commentary. Viewer C discovers the Italian version of Event X and replaces it with a Turkish Commentary. The sales system 100 allows for each change element 906 in the event 406 to trigger another opportunity for advertisers 102.

This sales system 100 may also allow changes in content to reach more viewers 106 than the original broadcast event 406. For example, a retired football player adds his own commentary to the US broadcast of a College Football game. The change in content attracts a new audience as fans of the football player and the like pass on the event to friends and family. The original broadcast was expecting to reach a younger viewing audience however the new commentary, acting as an element of change 906 alerted advertisers who could then modify and or offer new Advertising placements.

The sales system 100 further allows the 3^{rd} (or 4^{th}, 5^{th} etc) generation broadcasts to continue to gather more viewer 106 interest, which could lead to greater advertising opportunities and increased revenues for the original content provider 101.

The on-line production element of creating a new market can also allow individual IP addresses 106 to be targeted based on IP information allowing unique advertising to be targeting to each Viewer 106.

Viewer-Content Owner Advertising During an Event

The sales system 100 can also allow viewer 106, content providers 102, merchants 108 and individual broadcasters to insert their own advertising into a broadcast. This sales system 100 can be managed using various elements of change 906 within the production system.

For example, the original content owner and or broadcaster could advertise their own product and or service. For example, A music school 108 creates entertaining and informative content that enhances the reputation of the school. The event 406 can be ‘entertaining’ and educational while at the same time is an effective (type of) advertisement.

The sales system 100 can develop a platform that manages a cross marketing campaign with other similar products and services 108 (e.g. A guitar maker shares a platform with other instrument makers).

The content creator/owner 101 can garner interest from advertisers 102, requested advertisement 803, and or sales process 103 based on viewer-ship, subject matter etc. For example, a famous musician can play an instrument and tout what he loves about it and say, “I am not just a spokesman but a satisfied customer”.

The sales system 100 can also embed advertising into each broadcast based on such abstracts as content subject matter, or popularity of a producer, or on the IP activity (etc) into the interactive broadcast.

Advertisers 102, requested advertisements 803, and or sales process 103 can secure placements and or change ads based on key words, dramatic changes in an event broadcast 906 and the like. The sales system 100 allows these elements of change 906 to ignite the sales process 103.

For example, an incredible comeback in a sporting event could induce a series of ads based on this subject (champions, never give up etc).

In another example, Honda sponsors a Formula 1 race in Los Angeles. Throughout the event Honda inserts targeted ads of it's latest cars to viewers. The process allows Honda to place different ads, different deals and or promote different local Honda dealers to each viewer, based on his/her profile and or IP address.

In another example, during each event broadcast of Cornell University's sporting program, the college places ads that the promote the virtues of the college. The process allows different versions of each ad to target potential students based on such characteristics as their education background, family income, sporting prowess and the like.

In yet another example, a live concert event featuring Band X could include direct advertising from Band X to its fan base.

The sales system 100 can enable a more flexible system for advertisers 102 who can benefit from changes in broadcasts and consumer interest. The gathered data, of all the change factors, stored in the production system 105 could empower advertisers, 102 requested advertisements 803, and or sales process 103 to make better decisions relating to the creation and managing of ads for targeted audiences. The change factors 906 could provide focused platforms from which advertisers 102 could reach interested buyers, and or ask pertinent information from the consumer on why and how that want to be sold and or even by whom they would like the message delivered and or even what they are in the market for and or when they will be in the market for such product or service and or even where they would like purchase the product or service.

The broadcaster and or content providers 101 can also benefit because of the greater potential of Income derived from Audience follow through. For example, the target ‘subject’ based advertising allows the consumer to be in control of the whole process while, concurrently the advertisers have access directly to each consumer throughout the whole sales process.

Customer Activity Within an Event: Creating new Advertising Interest.

The sales system 100 allows a Viewer 106 or a group of Viewers interaction to induce new advertiser 102 interests. For example, a radio styled Talk Show event includes the interaction and or broadcasts of ‘viewers’ within the event. The interaction of one regular Viewer could create demand from advertisers to include this viewer on a regular basis. The viewer's popularity and or notoriety may encourage advertisers to invest and or create a new event that features this viewer.

In another example, a Live Broadcast of an Auction encourages the viewer interaction to open up new viewing audiences and advertiser involvement. In another example, an auctioneer interacts with (let's say) 20 interested ‘buyers’ each of whom share the event with friends and families. The sales system 100 allows advertisers 102 to be alerted by the viewer 106 interested in the auction and or items being auctioned. Advertisers 102 may be allowed to target viewers 106 with Ads promoting similar products and or services.

In another embodiment, the interaction of viewers 106 during an auction creates a type of Reality TV phenomenon that entices additional viewers 106 (potential buyers and sellers) and or merchants 108 into the interactive (bidding) element of the event 406, site, or channel. The additional interest from ‘viewers’ 106 can trigger advertising that could be considered of general and or IP specific interest, according to an embodiment.

The sales system 100 also allows viewers 106 to view (and or listen to) a product demonstration of (let's say) A Vintage Guitar. In one embodiment, advertisers 102 of other similar products are given the opportunity to enter into the interactive process with their own ads.

This part of the sales system 100 could also support multi-language broadcasts and or the ‘pass it on’ methods 906 so that buyers and sellers from around the world can interact within the same live Auction.

This sales system 100 can allow advertisers 102, to up-sell 601 related products and services to interested buyers 106.

The sales system 100 also allows certain production elements and or Viewer 106 involvement to trigger advertising placements.

In one embodiment an Advertiser 102 agrees to sponsor an event 406 once a viewing audience (numbers, demographic etc) and or certain Viewer 106 actions take place.

Advertiser Activity in an Event: The sales system 100 allows activity from one advertiser 102 to alert and or induce another advertiser 102 to bid and or seek placement inside an event 406. The sales system 100 also allows one sponsor's 102 involvement in an event 406 or channel to trigger the interest and involvement of another sponsor 102 and so on.

This type of interaction amongst Advertisers 102 can be spontaneous, predetermined and be based on bidding and the like, according to an embodiment.

Advertisers 102 can select a ‘what if’ category in the bidding process effected by viewer 106 and advertiser actions 102, according to another embodiment. For example, the makers of Product X bid to be placed in the same broadcast of Product Z if and when that product secures a placement in a broadcast event and or if a certain Viewer requests another product advertisement. The requested advertisement 803 could be deemed to have a higher value because the consumer 106 is requesting that product type or even brand. This could give advertisers 102 a better understanding of the time frame that the consumer is looking at, to make the purchase.

Consumer Activity that Effects Advertising

Viewer (Member) Process: Once a viewer 106 logs into the production system 105 (channel, network etc) his/her IP address 106 can enter the database 508, inside the production system 105 which manages the flow of content and advertising. The viewer 106 may become a member, which may involve the development of a personal preference folder. The preferences may be viewed and managed by the viewer/member 106 and or updated and managed by the production system 105. The production system 105, may also provide the viewer 106 with such tools as a shop-bot or sales-bot and the like, to procure the best deals on products, or to find content in the requested content schedule 807, or search out requested advertising 803 and the like.

The sales system 100 also allows the viewer 106 to develop product and service categories in which he/she creates requested advertising 803 lists. The sales system 100 further allows Viewers 106 to be as specific as he/she desires, even down to that actual brand of a product.

Though IP address 106 information may be made available from 3^{rd} party sources, the activity and interaction within the sales system 100 and the managing of the Member Personal Folder can assist both the viewer 106 and the ‘Channel’ as to the quality of the product or service, the types of advertising and events 406 offered to the viewer/member 106. The viewer 106 can also state how best they would like to be serviced and what they consider of value in the production system 105.

The viewer 106 can at any time interact with the advertising process in such methods as: blocking an Ad (or type of product, brand etc), Save an Ad ‘for later’, 906 Ask for more information and or enter the sales process 103 on a specific produce or service or ask for a Salesperson 602, Make a purchase, Pay to Block advertising (e.g. For an event or more), Request types of Advertising 803, Accept a fee (or reward) for viewing and or participating in an campaign and or market research study, Rate an Ad, Pass on (share) an ad 906 with another member or group of members and the like.

In one example, on the Channel page an opaque overlay allows full screen view of the content, while at the same time allowing the viewer to click on the type of ad he/she wants to watch inside the overlay or inside the media player and the like.

In another example, a viewer/member 106 viewing an event 406 can ‘click on’ (select) an ad within the media player and or the channel page. To activate the interactive process of advertising the viewer 106 may also ‘drag’ the ad icon (or similar) 901 over to an Interactive Ad Folder and or onto the desktop. This action may prompt a pop up window to appear requesting further member actions. Inside the pop up window, the viewer 106 may be offered a list of choices (Buttons) such as Block this Ad, Save this Ad, Request More Information, Ask for a Salesperson, Buy this Product, etc. On selecting one of these ‘Buttons’ another window may appear offering the viewer 106 the choice of activating this action ‘now’ or ‘later’. Activating the ‘Now’ Button can cause immediate and yet different consequences for each option based upon the actual request or choice. This action may result in the broadcast event to be placed in ‘pause’ mode. Activating the ‘Later’ Button may allow the viewer 106 to continue viewing the event without the distraction of viewing ads during the event broadcast. The member could view the ad at a more suitable time.

The viewer 106 could set up preferences for viewing ads ‘Later’, which could assist in the management of this folder. E.g. Once the viewer 106 has finished viewing an event, the ‘later’ ads could appear in another pop up window prompting further action from the viewer 106. The viewer 106 may at this time continue the process by selecting a button to ‘view’ each ad, delete an ad and or putting an ad on hold for later. The Ad preferences may continue to remind the viewer 106 of the unseen ads until the viewer 106 finalizes the process (one way or another). In addition, advertisers 102 can be alerted of any member activity and may choose to send a reminder notice (via email, text, another ad etc) to view the ad and/or complete the process.

Descriptions and Types of Actions and ‘Buttons’

Blocking Advertising: A viewer 106 can block an ad, a type of ad, a type of product and or products and ads relating to specific and or general topics (e.g. Health Care, Political, and Sport, etc). Once a viewer 106 blocks an ad (etc) this information can become part of the viewer's Personal Preference Folder inside the production system 105.

Save an Ad: A viewer 106 can save an ad that can be viewed later. The initial action of ‘clicking to save’ can alert advertisers 102 of the viewer's interest in an ‘item’ or product. This action may cause advertisers 102 to be charged a fee. The viewer 106, at his/her convenience can delete, view, and or respond to the ad. This ‘later’ action may also affect another fee charged to the advertiser 102.

Ask For more Information: By clicking this button the viewer 106 may receive more ads (more specific in nature to the requests of the member), or the viewer 106 may be directed to another site containing more information. The viewer 106 may also be offered the services and expertise of a ‘real’ person 602. This action of asking for more may lead to direct sales 103 for the advertiser 102.

Make a Purchase: At the convenience of the viewer 106, by selecting this button a new window may appear offering the options and deals to the selected product. The viewer 106 may also be offered the services of a real person 602 to help during the purchasing process.

Request a Salesperson: At anytime during the interactive process a viewer 106 may either be offered this service and or select this service. The salesperson 602 and viewer 106 can interact (via such methods as multi media). This action may result in the salesperson 602 up selling 601 products and services to the viewer 106.

Pay to Block Advertising: A viewer 106 may wish to view an event 406 without the distraction of any advertising either within the media player or the channel page. A Channel may offer a service to the viewer 106 having a fee that either restricts and or removes advertising. This fee could vary for each event 406 and may be based on estimated revenues ‘lost’ because of the blocking action.

Request Advertising: A viewer 106 can request the advertising 803 of products that are of interest to him/her. These requests 803 may differ from viewer 106 and viewer's IP preference 106 information (e.g. new interests, a present for a friend etc). This action alerts advertisers 102 who may not have considered the viewer 106 suitable for targeted advertising. This alert could result in fresh bidding activity for advertising placement.

Scheduling Preferred Advertising: Viewers 106 can request certain ads 803 and or types of ads and schedule them for events. For example, a viewer/member planning to watch a major sporting event can request ads to be placed during ‘regular’ ad placement times. This could enhance the viewer's 106 viewing experience and result in greater bidding and interest from advertisers 102. Secondary levels of viewer 106 and advertiser 102 interaction may take place because of previous results.

Incentives to View an Ad. Because of viewer 106 responses to ads, advertisers 102 can offer viewer 106 incentives such as, view ‘other’ ads, carry out a survey, rate ads, create ‘your’ own ad, participate in market research and the like. A viewer 106 that has blocked a certain type of ad may be offered an incentive to reconsider. For example, Incentives may be in monetary form or such ‘currencies’ as points, tokens, and free passes, each containing value with the Channel or network e.g. rent a free movie, free mp3's, tickets to a sporting events, concert, nightclub, and the like or watch an event without advertising and the like.

Rate an Ad: Once a viewer 106 has viewed an ad, this action may prompt a new pop up window asking the member to rate the ad. The viewer 106 can ignore the window. The next on screen viewer 106 action (of any sort) may remove the pop up window from the screen. A viewer 106 could also block or limit this ‘rate’ option. For example, if the viewer 106 selects the ‘yes’ button, the member may be offered several methods of rating. e.g. Rate this ad out 1 to 5 or would you recommend this ad to a friend and the like. The action of clicking yes and or the interaction with a ‘simple’ rating system may lead to another window offering a more thorough rating system. This sales system 100 could also offer the viewer 106 further incentives for his/her continued involvement.

The rating of ads may also cause other viewers 106 to request or seek out ads, according to an embodiment. A channel and or event 406 based rating system could allow viewers 106 to vote 906 for their favorite ads. This action could result in greater product awareness and sales (direct or other) for the more highly rates ads.

Pass the Ad On: The viewer 106 may also be given the option of passing on 906 or recommending the ad ‘to friends’ or other viewers 106. This action may result in a reward from the advertiser 102. e.g. If the passed on ad effects a sale. An ad passed on by a viewer 106 of notoriety (celebrity etc) may cause more interest from other viewers 106. This is a type of sponsorship and may result in further incentives offered to viewers 106 by advertisers 102.

Advertiser Process: The sales system 100 allows an advertiser 102 to become a Client of the Channel and Network. An advertiser 102 can be provided with a list of events, a list of factors that may cause a change within an event 906 due to Member action, and another list containing any relevant market information and potential viewer 106 information.

Advertisers 102 can bid or pay a fee for placement based upon any pertinent factors of the sales system 100. Advertiser's 102 can provide the production system 105 with finished ads with any relevant information pertaining to markets, IP criteria 106, bidding and payment budgets.

Once an Advertiser's 102 submits an ad into the production system 105, it can become subject to the governing forces of the sales system 100. An advertiser 102 could win or lose a place based on bidding, member actions and or interactivity and other advertiser 102 actions.

Each Advertiser 102 can manage data on a dedicated Client page. This option may allow advertisers 102 to manage preferences, view alert history, placement history, study trends and the like.

Bidding: The advertiser 102 could place a bid on event 406 (broadcast), on a market (or region etc), or a viewer 106 (or type of member) or on any of the member actions described in the member process.

Advertisers 102 could recognize, target and bid on specific members 102. Some members 102 could be considered as more valuable targets than others, based on such factors as income, spending history, interest in certain products, browsing history, actions within the interactive sales system 100.

The actions of the viewers 106 in regards interactive advertising can provide unique consumer information to advertisers 102. A common action by ‘types’ of viewers 106 may alert advertisers 102 to change or continue advertising methods and or products offered. The sales process 100 allows advertisers 102 to respond to the actions of members or viewers 106.

Viewer Blocks Advertising: This viewer 106 action could allow advertisers 102 vital information as to why their product and/or service has been blocked. The advertiser 102 could offer incentives to the viewer 106 to view and or interact with a survey and or other advertising. This action may encourage the viewer 106 to remove the blocking option. It may also lead to a ‘deeper’ relationship between Advertiser 102 and viewer 106, which could result in sales.

Viewer Saves an Ad: The initial action of ‘clicking to save’ 906 can alert advertisers 102 to the viewer's 106 interest of an ‘item’ and or could allow the advertiser to invite the viewer 106 and or viewer to enter the sales process 103 of their product or service. This member action 906 may cause advertisers 102 to be charged a fee. If the viewer 106 views or interacts with the ad a second (or multiple) times and moves through the sales process 103 the advertisers 102 could be debited other fees. The initial viewer 106 action can encourage the advertiser 102 to pursue the viewer (or type of viewer) with further advertising.

Viewer Asks for More Information: This viewer/member action 906 can allow advertisers 102 to take the viewer 106 targeted advertising process to the next level. This viewer/member action 906 could also alert the ‘sales department’ 103, 601, 602, 603, 104 to approach the viewer 106. By clicking this button 906 the viewer 106 may receive more ads (more specific in nature to the requests of the viewer/member), or the viewer 106 may be directed to another site containing more information. The viewer 106 may also be offered the services and expertise of a ‘real’ person 602. This action of asking for more may lead to direct sales 103 for the advertiser 102.

Viewer Makes a Purchase: This viewer 106 action could allow the advertiser 102 an immediate direct sale. By selecting this button, the viewer could be given a pop up window offering various options and deals relating to the selected product. The viewer 106 may also be offered the services of a real person 602 to help during the sales process 103. This direct contact could allow the salesperson to up sell 601 goods and services.

Request a Salesperson 602: At anytime during the interactive process 103 a viewer 106 can either be offered this service and or select this service. This option could allow a viewer 106 to skip any advertising and go straight the sales department of a requested product or service 803. The salesperson 602 and viewer 106 can interact (via multi media). This action may result in the salesperson 602 up selling products 601 and services to the viewer 106.

Request Advertising: 803 this viewer 106 action can alert advertisers 102 to potential (pre-qualified) customers 106. These requests 803 may differ from viewer 106 and IP preference information (e.g. new interests, a present for a friend etc). This action alerts advertisers 102 who may not have considered the member suitable for targeted advertising. This alert could result in fresh bidding activity for advertising placement.

Schedule Requested Advertising 803 this viewer action may encourage advertisers 102 to increase viewer/member bidding, offer incentives to viewers, and or develop specific advertising for viewers 106.

Viewer Pays to Block Advertising: This viewer/member action could alert advertisers 102 to unique consumer information. Advertisers 102 could target viewers 106 who pay to block advertising using different follow up methods of advertising.

Rewarding Viewers: Viewers 106 who block ads 906 or pay to block ads may be targets of unique follow up advertising campaigns. Advertisers 102 may offer certain viewers 106 incentives to view ‘other’ ads, participate in market research etc. Advertisers 102 could also offer incentives to members 102 to rate ads 906 on a variety of factors, such as effectiveness, relevance, purchasing interest and the like. Advertisers 102 could also offer similar incentives to both interested and disinterested viewers 106 to participate in market research. Advertisers 102 could also reward viewers 106 who recommend or share ads 906 with other members 106.

Sales Process

Production System: The production system 105 manages the content, the broadcasting of content, and the distribution of content, the interaction between viewers 106, content providers 101, and advertisers 102 and the international markets and or IP preferences. The sales system 100 allows the production system 105 to learn from viewer 106, content provider 101, merchant 108 and advertiser 102 activities.

The Viewer and the production system 105: When a viewer 106 logs into the system the IP (Internet Protocol address) can be registered in the database. Activity, such as viewing, browsing, interacting, advertising interest, purchases etc can be collated by the data engine 508.

Viewers 106 can request content 803 and the production system 105 is able to provide the viewer 106 with a complete content schedule. For example, a TV Guide can be sent to the viewer 106 who could examine the guide on any media device such as a cell phone, PDA, Blackberry, iPhone, Laptop and the like. The TV guide can help the viewer 106 manage the request content 803 schedule. The sales system 100 allows the viewer 106 to watch what he/she wants when he/she wants to watch it. The sales system 100 further allows ads such as product placement to be inserted into the content as the viewer 106 is watching it.

A viewer 106 may become a member, which may incur benefits from content providers 101, advertisers 102 and or the manager of the process (channels or networks).

Advertisers: As Clients of the process, advertisers 102 can submit ads, bidding information, target market preferences in to the Data Engine 508 and or production system 105.

As Clients, Advertisers 102 can manage unique data in an effort to maximize advertising opportunities. Though an advertiser 102 may receive notice member actions 906, can choose to learn from such actions and respond now or later to such actions.

Viewer Actions: The production system 105 can manage and interpret each viewer 106 action 906. This process could allow for immediate responses within the production system 105 from Advertisers 102.

The production system 105 can be continually updated with data relating to viewer 106 and advertiser 102 actions. This could include new actions, history of actions, and or events (and or factors effecting actions). It could also create lists of more common actions or actions that cause change (in varying degrees) within viewer habits and or success of advertiser actions.

The production system 105 can concurrently monitor member actions 906 and alert advertisers 102, which could induce new advertiser 102 actions.

Examples of Advertising and Viewer/Customer Interaction

An event broadcast 406 could offer a viewer 106 the ability to alter the manner in which advertising is presented. While viewing a broadcast a viewer 106 can select to view advertising ‘later’ 906.

In one example, a viewer 106 watching a sporting event may notice an ad about a product that he/she is interested in. However, the customer does not want to interrupt the broadcast, so he/she is able to select the ad to be viewed at another time. The ad(s) may reappear once the ‘game’ is over or the customer may hold the ad(s) for a more convenient time. The original ‘click through’ can be charged to the advertiser 102. A secondary ‘charge’ may also be applied once the viewer 106 comes back to view the ad etc. Continued interaction between viewer 106 and advertiser 102 may lead to continued fees debited to the advertiser 102.

In another example, this initial click demonstrates viewer 106 interest, which can educate advertisers 102 as to product and ad interest and or success. Another example could allow a viewer 106 to pay to remove advertising for an event 406, or portion of an event and or content.

In one example, a viewer 106 watching an intense drama does not want to be distracted by advertising. He/she could agree to pay a fee to watch the drama without advertising. The fee paid by the viewer 106 could match any advertising revenues lost by the producers, content providers 101, and Network managers and the like.

In another example viewers 106 could manage and or schedule advertising directed towards them. For example, a viewer's IP 106 information can empower advertisers 102, and the process could allow the viewer 106 to request advertising 803 based on his/her interests at any given time or season. Some of these product requests may differ from existing IP or customer information.

This method could also encourage viewers 106 to create their own unique viewing of an event 406 (e.g. a sporting event) to include product advertising of interest to them. This type of viewer 106 interaction within the sales system 100 could encourage viewers 106 to be more involved and or interested in advertising. Unlike TiVo, the interactive sales system 100 may help to maintain viewer 106 interest in advertising throughout a broadcast.

The sales system 100 allows advertising to be sold per usage and or market. For example an advertiser 102 can pay for the originally intended broadcast to US viewers 106 however; an additional fee may be charged once European viewers 106 log on.

Advertisers 102 may also participate in pay per view events 406 and share in the revenues, and or then have the ads viewed once the live pay per view event 406 has shown. Advertisers 102 may also bid for placement in any of the different methods of advertising and or content broadcasts. Advertisers 102 may be ‘charged’ according to the viewers and P2P 106 involvement. A niche event 406 that succeeds in such a grass roots promotion could result in advertisers 102 bidding for placement in future broadcasts.

Advertisers Bidding for Markets, Regions, and or Individuals

Some viewers 106 could be identified to have more value to Advertisers 102 than other viewers 106. This could encourage competitive bidding that could lead to higher income streams to the content provider 101 and or manager of the sales system 100.

In one example Viewer X 106, with an income of $200,000 could be considered more valuable to advertisers 102 than Viewer Y 106 who has an income of $40,000. Viewer X 106 could be considered to have greater spending power and advertisers 102 could be willing to raise their bids to win the attention of Viewer X 106. Each product has a customer profile that is more likely to buy their product or services and as the consumer go through the sales process profile questions are asked data engine allows advertisers to bid for consumer.

This sales system 100 could also apply to viewers 106 who have a history of browsing and purchasing certain types of goods and or services. Advertisers 102 of similar products and services may bid for such viewers' 106 attention.

The sales system 100 allows content providers 101 and or broadcasters to set a minimum bid amounts on a viewer 106 or group (type) of viewers, or a region, territory or market. This action could raise the bidding from advertisers 102 and increase revenues for content providers 101, producers, and broadcasters.

This method of data management could be considered speculative advertising. The advertiser 102 could place a bid that would be considered a debit when the new broadcast reached the ‘new’ viewer 106 and or markets.

How the Process Encourages Advertisers to Target Consumers.

Because the sales system 100 can allow for changes in each broadcast as it ‘passes’ through the production system 105, advertisers 102 could be given more opportunities to target specific viewers 106. This method also could allow advertisers 102 to bid for the right to advertise to a specific viewer or IP address 106.

In one example, two viewers 106 viewing the same event could be the recipients of two different sets of ads, some of which could be in the form of product placements. The advertisers 102 could select ads for each viewer 106 based on individual preferences.

The sales system 100 could allow viewers 106 to view content and ads using such devices as Cell Phones, telephones, PDAs, iPods, PCs, and GPS receivers and the like. This sales system 100 could encourage the viewer 106 to view content and or an ad because it has been tailored to his/her needs or preferences. The sales system 100 could also allow viewers 106 to block 906 certain advertising.

In one example a viewer 106 has no interest in Insurance, Medical Supplies, Sporting Goods, and Travel. The sales system 100 could allow this viewer 106 to modify his/her preferences in regards discouraging or blocking certain types of advertising. The sales system 100 could also allow the viewer 106 to manage a preference list in regards encouraging (or requesting) certain types of advertising 803.

In another example, these preferences could help Advertisers to ‘pursue’ viewers 106 who are interested in their product or product category. This method could also reduce advertising costs and resources wasted on disinterested viewers 106.

The sales system 100 allows for viewers 106 that are fans of a product to be the recipients of Informative ads while viewers 106 that are yet to be fans could be recipients of introductory ads or a nurturing ads 603. This method could assist advertisers 102 in developing ads to suit different levels of interest within the viewer 106 base.

The sales system 100 could save advertisers 102 from creating exotic and expensive campaigns in the attempt of wowing an audience. This sales system 100 could further allow viewers (members etc) 106 to be more easily identified as ‘interested’. This could allow advertisers 102 to take the advertising Campaign to the next level. This could also allow the identified interested viewer 106 to move more quickly into the sales process 103. The identified viewer 106 can also be nurtured 603 by the advertiser 102 via such methods as Q&A and the like. For example, a better-informed consumer could be more likely to make an immediate purchase and or create opportunities for the advertiser to ‘up sell’: which may include a more expensive model, or multiple model options of the product.

In another example, as a result of higher customer satisfaction, and or the developing relationship between viewer 106 and advertiser 102, this method of sales and marketing could enable viewers to become a more reliable source of information to advertisers and the like for future product development.

The sales system 100 also allows the advertisers 102 to offer viewers 106 a fee to view an ad, which could assist advertisers 102 in developing new products and or new ad campaigns. The sales system 100 could also allow viewers 106 who may have blocked an ad 906 or category product related ads, an incentive to view an ad campaign. In one example, the advertiser 102 allows the consumer, once he/she goes through the sales process, and or provides certain information, and or revises their member profile, and or say when they would be prepared to enter the market to buy this type of product or service, and the like, to have access to content and or events such as movies, music, and the like.

The sales system 100 could allow the advertiser 102 to use print, TV, Film, GPS, Internet and telephone mediums aimed at viewers 106 using Cell Phones, telephones, PDA's, PC's and GPS receivers and or who can be identified by subscriptions of media products and services.

The sales system 100 could also include the rating of Items 906 (advertising) by viewers 106. For example, these ratings could help advertisers 102 better understand the needs and desires of consumers.

The sales system 100 allows the gradual building of customer (viewer) profiles based on types of media interaction, travel (GPS), purchase history, as well as product and service interest and the like. Any viewer 106 activity could be of interest to the managers of the production system 105. For example, each video, Film, TV show, magazine, newspaper, radio station, website, podcast, blog, product or service interaction with the viewer 106 could provide valuable data for both the advertisers 102, content providers 101 and the production system 105. The data collected could help advertisers 102 locate the ideal customer/viewer 106 for their product.

The sales system 100 allows advertisers 102 hoping to reach a viewer 106, to bid for him/her. When the viewer 106 logs on (and or begins to subscribe to a publication, cell, or telephone company or begins watching a broadcast or searches a website and the like), the highest bidding advertiser 102 could win the chance to advertise to that viewer 106.

Advertisers 102 can maximize their expenditure by focusing on viewers 106 whose profile may indicate an interest in the advertisers 102 Item. In one example, a TV spot during a prime time movie could allow advertisers 102 to bid for each individual viewer 106. The specific time slot could have millions of different ads going out to precision target markets. In another example, two customers tuned into the same radio station could hear two different ads, in another example; two customers reading the same publication or web page could see different ads based on their profile.

Interactive Sponsor

Another embodiment of the invention relates in general to an interactive programming, advertising and sales system 100, and more particularly to manipulating content received over the Internet to create customized programming, broadcasting and advertising, requested advertising 803, and sales process 103 that leverages national and international brand recognition.

The benefit of a national brand is that the public at large generally recognizes the goods/services of the brand because it either sees and/or hears the repeated message “buy my brand now” at the national and regional levels. The challenge is making that message relevant at the local level and more importantly, converting that national message at the local level to “buy my brand now—from me.”

While National Ads (using traditional media formats like TV, Print etc) offer National Brand recognition and mass appeal it is the local markets and local culture that advertisers need to penetrate.

Viewers/consumers 106 are more likely to identify with the national brand when there is an emotional connection. Local events such as High School or College sports provide ideal mediums for national/regional brands to localize their message and make an emotional connection with viewers 106. The fan-base of each Sports teams provide the national brand with a ready-made target market.

Reaching out to viewers 106, through such mediums as sports, sponsors 102 can focus on the desired target audience at the local level. National/Regional Sponsors can determine the demographic profile of its customer through the various sport channels on the iBN Sports network (i.e. Professional, College and High School sports like Baseball, Football, Skateboarding, Surfing, Snowboarding, Ivy League Sports, Mixed Martial Arts, etc.) that it desires to reach.

An advertiser sponsors 102 a local event by subsidizing the broadcast and production costs. A sponsor 102 may use some of its national advertising campaign budget to produce a higher quality broadcast event 406.

In one example, a sponsor 102 guarantees a portion of its advertising budget to produce and broadcast a College Football game. The event can be broadcast over the Internet 107 at a fraction of the cost of TV, Cable and Satellite.

In another example, All State Insurance 102 guarantees the TV quality production and broadcast costs for a local High School Football game (or season). The event(s) 406 is broadcast live (and or made available for later viewing) on the Internet 107.

Though other advertisers 102 may pay (or bid) for the rights to advertise during the event (and or during any subsequent viewing or download) the Sponsor 102 may be allowed certain privileges that restrict similar and or competing brands from participating in the event 406.

By sponsoring a local event 406 the advertiser 102 may be able to use localized media formats to reach it's target audience.

In another example, during the broadcast of a football game 406, a National TV commercial for an insurance company appears. For the local audience, a different and or edited version of the ad replaces the original ad, so that the local agent can be featured in the ad. Also, a Coupon window may pop up showing the local agent in the zip code area of the (logged on) fan. e.g. All State 102 is the sponsor, and John Smith's 108 name, his details, and a friendly video “hello” video message appears in a window offering a “click here for interactive sales” options. Other options may include insurance rebates, free quotes, special offers to fans, players, family and alumni of the team and the like and or the opportunity to speak to a live salesperson 602, which may include John Smith 108.

For sponsoring the event 406 the advertiser 102 may also be given certain privileges such as access to the coaches, players and alumni tailgate parties, for the development of other sponsor related programming e.g. A Mid Week Coach's Corner, Interviews with players and the like. This may lead to other types of interaction such as sponsoring the team's homepage, or the coach's facebook or myspace page.

By sponsoring a local event 406 the advertiser 102 is able to introduce and or promote the local stores or representatives 108 (via the coupon) to the local market. The Sponsor 102 may edit a national TV ad to include and or promote a local agent 108. By Sponsoring local events, local store managers or sales people can attend local events. e.g. AllState local vendor John Smith 108 is invited to the local school fund raiser (with local press attending) to announce the sponsorship. Or Local rep can come to the tailgate parties, interact with Alumni etc This community good will could translate into more sales, and or supportive long term customers.

By sponsoring local sporting events advertisers 102 can make an emotional connection with the consumer. e.g. All Sate is able to reinforce it's national campaign (“You're in Good Hands with All State”) by attaching it's brand to the broadcast of a sporting event (i.e. “The Good Hands Halftime Report”) and to reach out to that local customer at the local level. The sponsor's local agent 108 can design and target advertising to the demographic reach of each sporting event (i.e. Print out this coupon for a discount on premiums if you have teen-aged drivers in your household and see your local All State representative—John Smith).

In another example, All State's national Ad campaign (as seen on TV) can be re-aired on local broadcasts as part of the local events . . . reinforcing the brand at a local level. Segments of the original 30-60 second national commercial spot can be edited into interactive sales promotion spots, and or the viewer/consumer 106 can enter the sales process 103 incorporating local agents 108. Interactive sales promotion is achieved through, entering the sales process, email contact, coupons, live events like tailgate parties, live feed video interaction (chatting, texting) and the like.

In another embodiment, the production system 105 and sales process 103 could allow the brand to communicate simultaneously with an international audience and the individual viewer 106 in a local market.

In another example, Cadillac sponsors an Ivy League network covering the costs for all sporting event broadcasts. Local Cadillac dealers 102, 108 target viewers 106, recognized by such protocol as unique IP address and Zip Codes and the like. The viewers 106, at various intervals during the broadcast can enter the sales process 103 each viewer 106 may be offered unique interactive Coupons based on such information from the production system 105 such as profile, preferences, shopping history, income, education and the like, coupons may offer viewers 106 the opportunity to test drive a vehicle, special leasing offers, watch another ad and or talk to a salesperson 602 (and the like).

In another embodiment, for volunteering personal information, a viewer 106 may be offered incentives, such as free tickets to sporting events or to an event of their choosing. In another embodiment the Broadcaster may be rewarded by the actions of a viewer 106.

In another embodiment an advertiser 102 pays for each level of the viewer 106 interaction in the sales process 103 with an ad. For example, the Viewer Clicks on a Cadillac Coupon, then clicks on the Coupon to watch more advertising, then clicks on a page to view pricing, then requests to speak to a salesperson. Each action warrants a fee, paid by the advertiser to the broadcaster.

In another embodiment the broadcaster or content provider 101 may be further rewarded once a viewer 106 test drives an advertisers product. For example, a viewer responds to a Coupon promoting a test drive at a local Cadillac dealership 108. Once the viewer actually takes the drive, the local dealer pays an agreed fee to the broadcaster.

In another embodiment the broadcaster or content provider 101 receives a commission from an actual sale emanating from viewer 106 interactions with an advertiser 102. For example once a viewer makes a purchase from the advertiser the broadcaster receives an agreed fee.

In another embodiment the broadcaster or content provider 101 receives an additional fee when the viewer 106 requests advertising 803 and enters the sales process 103 and or when the advertiser 101 up sells 601 a product to a viewer 106. For example, for each action of the viewer, such as responding to an ad and or entering and or completing the sales process, and or clicking on a sales coupon and or purchasing a product and or requesting a live salesperson, and the like, the content provider earns a fee. In another example the content provider earns a percentage of an up sell.

In another embodiment, an advertiser 102 can forgo the price of advertising and pay a higher percentage of each sale, generated through the event 406, to the broadcaster. For example, A Local Cadillac Dealer pays nothing for the click through advertising, however pays the broadcaster $100 for every sale.

This process 100 may allow smaller or local vendors 108 to participate in locally broadcast events 406 without risk. It may also encourage vendors 108 who are skeptical of the opportunity to test the sales system 100. This type of advertising may be considered the last mile in a sales process 103 from a national to regional to local to the actual customer 106.

Now that national Telcos are replacing the local telephone and cable services, providing fiber optic to every household and business, consumers 106 are able to communicate and interact on a world scale. Once a viewer 106 enters the interactive sales system 100, he/she can view, edit, produce or even be a guest on a program not to mention buy or sell goods and services or broker a business deal without ever leaving home.

Radio Becomes TV

By streaming video/audio content live over the Internet 107, a local radio station content provider 101 becomes a national/international broadcaster.

In one embodiment the local radio station content provider 101 introduces the local audience 106 to the national sponsor 102. The local audience can respond on a local level to a national campaign. For example, the radio station 101 provides direct access for viewers 106 to interact with local agents 108 for the national sponsor 102.

In one embodiment the radio station content provider 101 sells advertising based upon viewer IP or Zip code 106 and the like. In another embodiment the radio station content provider 101, by virtue of it's wider audience can now sell national/international advertising. In another embodiment local radio station content provider 101, utilizing the Internet 107 as the entertainment delivery system, integrates a national TV brand campaign to its local radio audience.

National to Local and Local to National

With radio's high emotional appeal and community outreach national advertisers 102, are introduced at a grass roots level to the local community. Using high quality TV ads on local Internet radio, sponsors 102 are given the opportunity to introduce and promote the local Agent, Rep, or store 108 and make a direct connection with the local viewer/consumer 106.

The process 100 may also allow Local brands 102 the attention of the national and international markets, making the national customers 106 local for the first time.

Local radio producers can now turn their audio (only) shows into a full TV (video/audio) broadcast productions. They can also invite their audience to join them on their show live in person (by calling into the radio station with added video via Live Internet broadcast).

Just like Tivo their viewer/customers 106 can select programming to be watched whenever, which increases overall viewer-ship and advertising opportunities. The process 100 also allows radio station content providers 101 to reach national and or international markets, which entices national and international sponsors and advertisers 102.

Local/National radio station content providers 101 become television stations, which creates new viewers 106, better serves existing viewers 106 and increases advertising opportunities and revenues while keeping the local feel of radio.

Viewer Creates Custom Advertising: To better serve the viewing experience of the viewer 106, and allowing advertisers 102 to concentrate on precision target consumers, viewers 106 can customize the types (and or product categories) of advertising they receive during a broadcast by requesting advertisements 803 and or sales process 103.

A list of genre (type) advertising allows the viewer 106 to select the kind of advertising he/she wants to view or receive during the event 406 (and or future events). The lists can be modified at any time. This immediate level of sales interaction provides the advertisers 102 with prequalified customers, a service that is unavailable via traditional methods of advertising today.

In one embodiment, viewers 106 submit information such as zip code, email, age, occupation, income and the like, when they enter the production system 105. In another embodiment viewers 106 are given lists of product categories. Each viewer 106 could create a preferred list that may encourage advertisers 102 to target them for specialized advertising. For example, Viewer X may select product categories such as Travel, Wine, Cigars, Investment, Insurance, while Viewer Y may select Perfume, Groceries, and Automobiles.

In another embodiment, each product category selection may offer a further list of category options. For example Viewer X 106 selects Travel. The Travel list may open to another list offering travel related products such as Airlines, Hotels, Car rentals and the like. On selecting Wine, Viewer X 106 may be offered a further list with more specific product lines such as Regional Wine, Vintage Wine, Bargain Wine or varieties such Pinot Noir, Chablis and the like. Once the list is created, local or national vendors may pay to advertise on such methods as pay-per-click. The advertising may be general (product awareness) or customer specific.

For example, a local Wine Merchant 108, 102 targets Viewer X 106, offering enticements to purchase on line while a local Super market targets Viewer Y 106 with the offer of home delivery. Both viewers X and Y 106 receive advertising based on the product categories they selected.

In another embodiment national ad campaigns are infused into a local broadcast and by using such methods as a special Coupon, local reps 108 or brand franchises 102 are introduced to the viewer 106.

In another embodiment a national brand 102 uses local vendors 108 to target specific viewers 106. For example, in the Beverage lists the viewer selected “Imported Beer.” Local Liquor Markets or Supermarkets 108, 102 can target the viewer with ads, prices and specials relating to imported beer. The viewer 106 could select, make a purchase and have the beer delivered.

In another embodiment a viewer 106 could select an ad to be viewed later. The action demonstrates viewer 106 interest in the product to the advertiser 102. The ad may reappear after the event 406 allowing the customer 106 to take the next step in the interactive sales process 103.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of creating broadcast video comprising:
requesting or receiving programming content over the Internet;
manipulating the programming content with one or more computer processors to create a video broadcast based on input received over the Internet;
promoting products or services by inserting promotional material into the video broadcast based on one or more viewer interests; and
transmitting to a viewer the customized production with the inserted promotional material embedded therein.
